(19) United States
(12) Patent Application Publication
(10) Pub. No.: US 2011/0086238 A1
(43) Pub. Date: Apr. 14, 2011

(54) Niobium Nanostructures And Methods Of Making Thereof

(76) Inventor: Shrisudersan Jayaraman, Painted Post, NY (US)

(21) Appl. No.: 12/576,510

(22) Filed: Oct. 9, 2009

(51) Int. Cl. B32B 15/02; C22C 27/02; C25C 1/22

(52) U.S. Cl. 428/546; 420/425; 205/560; 977/762; 977/777; 977/899

(57) ABSTRACT

The disclosure relates to metal materials with varied nanostructural morphologies. More specifically, the disclosure relates to niobium nanostructures with varied morphologies. The disclosure further relates to methods of making such metal nanostructures.

### FIELD OF THE DISCLOSURE

The disclosure relates to novel metal nanostructures with varied morphologies. More specifically, the disclosure relates to niobium nanostructures with varied morphologies. The disclosure further relates to methods of making such metal nanostructures.

### BACKGROUND

Metal oxides, metals, mixed metals, metal alloys, metal alloy oxides, and metal hydroxides are material systems explored, in part, due to these systems having several practical and industrial applications. Metal oxides, for example, are used in a wide range of applications such as in paints, cosmetics, catalysis, and bio-implants.

Nanomaterials may possess unique properties that are not observed in the bulk material such as, for example, optical, mechanical, biochemical and catalytic properties of particles which may be related to the size of the particles. In addition to very high surface area-to-volume ratios, nanomaterials may exhibit quantum-mechanical effects that can enable applications that may not be possible using the bulk material. Moreover, the properties of a given nanomaterial may vary further depending upon the morphology of the material. The development or synthesis of each nanomaterial, including new morphologies, presents new and unique opportunities to design and develop a wide range of new and useful applications.

There are several conventional methods for the synthesis of nanomaterials, including those identified in U.S. Patent Application Publication No. 2009/0218234, which is incorporated herein by reference. However, as discussed therein, conventional methods may be disadvantageous because they may be energy intensive, employ expensive capital equipment, for example, high pressure reactors, involve tedious process steps, for example, cleaning, washing and drying of powders, and use harmful chemicals.

Thus, it would be advantageous to obtain new metal nanostructures and methods of making said nanostructures, particularly in large quantities in an economically viable fashion.

### SUMMARY

The disclosure relates to novel metal nanostructures with varied morphologies, and more particularly to niobium nanostructures. The disclosure further relates to methods of making the novel nanostructures. In various embodiments, the methods are electrochemical methods.

### BRIEF DESCRIPTION OF THE DRAWINGS

The accompanying drawings are included to provide a further understanding of the disclosure, and are incorporated in and constitute a part of this specification. The drawings are not intended to be restrictive, but rather are provided to illustrate exemplary embodiments and, together with the description, serve to explain the principles disclosed herein.

FIGS. 1a-1d are SEM micrographs of niobium nanostructures made according to one embodiment of the disclosure and as disclosed in Example 1.

FIG. 2a-2b are SEM micrographs of niobium nanostructures made according to one embodiment of the disclosure and as disclosed in Example 1.

FIGS. 3a-3b are SEM micrographs of niobium nanostructures made according to one embodiment of the disclosure and as disclosed in Example 1.

FIGS. 4a-4d are SEM micrographs of niobium nanostructures made according to one embodiment of the disclosure and as disclosed in Example 1.

FIG. 5 is an SEM micrograph of niobium nanostructures made according to one embodiment of the disclosure and as disclosed in Example 2.

FIGS. 6a-6b are SEM micrographs of niobium nanostructures made according to one embodiment of the disclosure and as disclosed in Example 1.

FIGS. 7a-7b are SEM micrographs of niobium nanostructures made according to one embodiment of the disclosure and as disclosed in Example 1.

FIGS. 8a-8b are SEM micrographs of niobium nanostructures made according to one embodiment of the disclosure and as disclosed in Example 1.

FIGS. 9a-9b are SEM micrographs of niobium nanostructures made according to one embodiment of the disclosure and as disclosed in Example 1.

FIGS. 10a-10b are SEM micrographs of niobium nanostructures made according to one embodiment of the disclosure and as disclosed in Example 1.

FIGS. 11a-11b are SEM micrographs of niobium nanostructures made according to one embodiment of the disclosure and as disclosed in Example 1.

FIG. 12 is an SEM micrograph of niobium nanostructures made according to one embodiment of the disclosure and as disclosed in Example 2.

FIG. 13 is an SEM micrograph of niobium nanostructures made according to one embodiment of the disclosure and as disclosed in Example 2.

FIG. 14 is an SEM micrograph of niobium nanostructures made according to one embodiment of the disclosure and as disclosed in Example 4.

FIG. 15 is an SEM micrograph of niobium nanostructures made according to one embodiment of the disclosure and as disclosed in Example 4.

FIG. 16 is an electrolytic cell used in methods according to embodiments of the disclosure, such as that described in Examples 1-4, below.

FIGS. 17a and 17b show the anodic scan of the cyclic voltammetry of a niobium substrate as described in Example 1.

FIGS. 18a-18c are SEM micrographs of niobium nanostructures made according to one embodiment of the disclosure and as disclosed in Example 1.

FIG. 19a is a schematic of a sample surface, and FIG. 19b is a collection of SEM micrographs of niobium nanostructures obtained from the positions indicated in FIG. 19a and as disclosed in Example 1.

FIG. 20 is an SEM micrograph of niobium nanostructures made according to one embodiment of the disclosure and as disclosed in Example 2.

FIG. 21 is an SEM micrograph of niobium nanostructures made according to one embodiment of the disclosure and as disclosed in Example 2.

FIG. 22 is an SEM micrograph of niobium nanostructures made according to one embodiment of the disclosure and as disclosed in Example 2.

FIG. 23 is an SEM micrograph of niobium nanostructures made according to one embodiment of the disclosure and as disclosed in Example 2.

FIG. 24 is an SEM micrograph of niobium nanostructures made according to one embodiment of the disclosure and as disclosed in Example 2.

FIG. 25 is an SEM micrograph of niobium nanostructures made according to one embodiment of the disclosure and as disclosed in Example 2.

FIG. 26 is an SEM micrograph of niobium nanostructures made according to one embodiment of the disclosure and as disclosed in Example 2.

FIG. 27 is an SEM micrograph of niobium nanostructures made according to one embodiment of the disclosure and as disclosed in Example 3.

FIG. 28 is an SEM micrograph of niobium nanostructures made according to one embodiment of the disclosure and as disclosed in Example 3.

FIG. 29 is an SEM micrograph of niobium nanostructures made according to one embodiment of the disclosure and as disclosed in Example 3.

FIG. 30 is an SEM micrograph of niobium nanostructures made according to one embodiment of the disclosure and as disclosed in Example 3.

FIG. 31 is an SEM micrograph of niobium nanostructures made according to one embodiment of the disclosure and as disclosed in Example 3.

FIG. 32 is an SEM micrograph of niobium nanostructures made according to one embodiment of the disclosure and as disclosed in Example 3.

FIG. 33 is an SEM micrograph of niobium nanostructures made according to one embodiment of the disclosure and as disclosed in Example 3.

FIG. 34 is an SEM micrograph of niobium nanostructures made according to one embodiment of the disclosure and as disclosed in Example 3.

FIG. 35 is an SEM micrograph of niobium nanostructures made according to one embodiment of the disclosure and as disclosed in Example 4.

FIG. 36 is an SEM micrograph of niobium nanostructures made according to one embodiment of the disclosure and as disclosed in Example 4.

FIG. 37 is an SEM micrograph of niobium nanostructures made according to one embodiment of the disclosure and as disclosed in Example 4.

FIG. 38 is an SEM micrograph of niobium nanostructures made according to one embodiment of the disclosure and as disclosed in Example 4.

FIG. 39 is an SEM micrograph of niobium nanostructures made according to one embodiment of the disclosure and as disclosed in Example 4.

FIG. 40 is an SEM micrograph of niobium nanostructures made according to one embodiment of the disclosure and as disclosed in Example 4.

FIG. 41 is an SEM micrograph of niobium nanostructures made according to one embodiment of the disclosure and as disclosed in Example 4.

FIG. 42 is an SEM micrograph of niobium nanostructures made according to one embodiment of the disclosure and as disclosed in Example 4.

### DETAILED DESCRIPTION

It is to be understood that both the foregoing general description and the following detailed description are exemplary and explanatory only and are not restrictive of the claims. Other embodiments will be apparent to those skilled in the art from consideration of the specification and practice of the embodiments disclosed herein.

The disclosure relates to metal materials with varied nanostructural morphologies and methods for making such materials. More specifically, in various embodiments, the disclosure relates to niobium nanostructures of varied morphologies.

As used herein, the term “nanostructures,” and variations thereof, is intended to mean nano-sized particles and includes subnanometer-sized particles as well, i.e., particles that are less than 20 nm. In various embodiments, the nanostructures may be of varied morphology.

As used herein, the term “morphology,” and variations thereof, relates to the structure and/or shape of a given particle.

In various embodiments, the disclosure relates to niobium nanostructures having strand-like morphology. As used herein, the term “strand-like,” and variations thereof, is intended to mean that the particles have fibrous shapes, for example, they may resemble strands of thread and/or ribbon, depending upon their size. In various embodiments, the strands may be substantially transparent. In various embodiments, the strand-like nanostructures may have a thickness of 20 nm or less, for example 10 nm or less. In various embodiments, the strand-like nanostructures may have a thickness ranging from 20 nm to 10 nm.

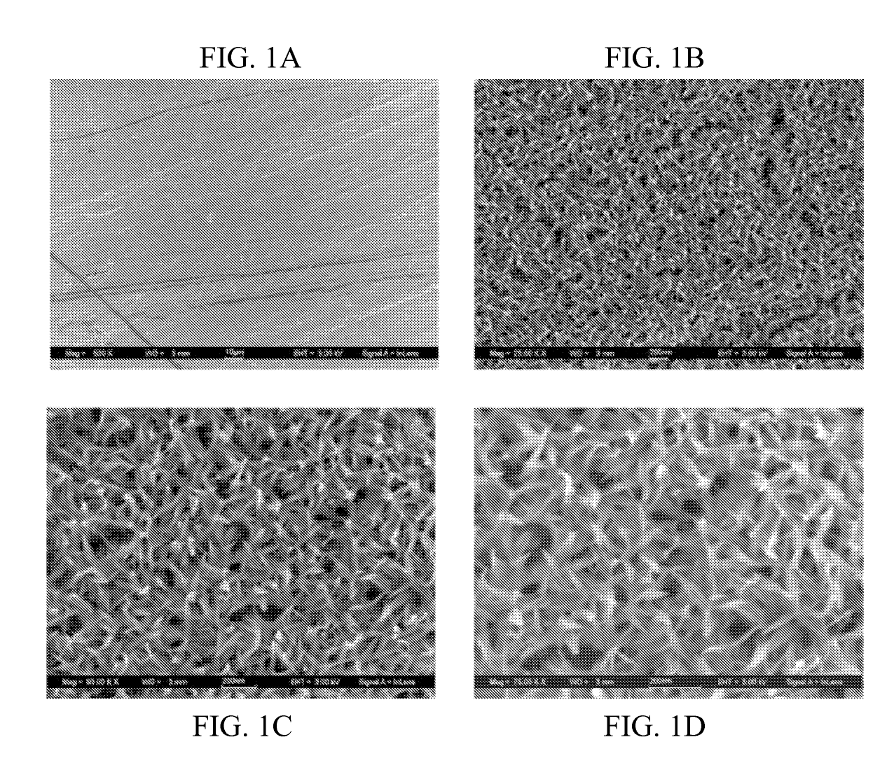

In various embodiments, the strand-like structures may be aggregated in a web-like form or webbed. As used herein, the term “webbed,” and variations thereof, is intended to mean that the strand-like structures may be woven together, may cross, and/or may intersect. The webbed forms may be random and/or have elements of order. FIGS. 1a-1d, 2a-2b, 3a-3b, and 4a-4-d are SEM micrographs of exemplary webbed strand-like structures and are further described in the examples below, along with other webbed strand-like structures.

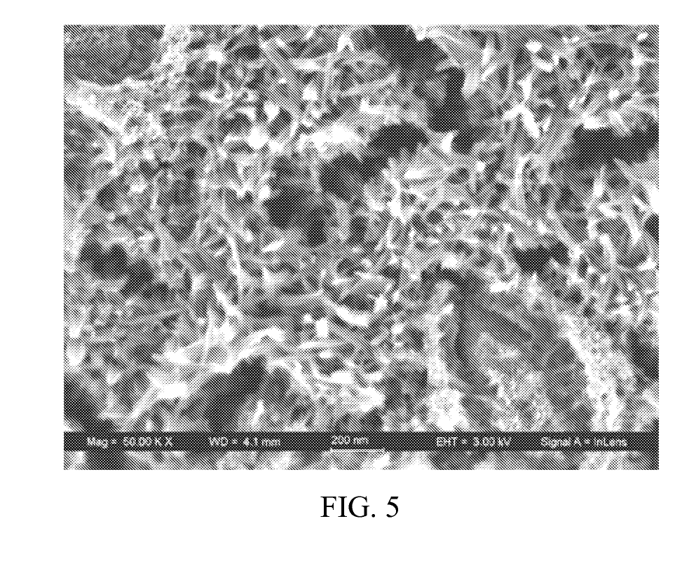

In other embodiments, the strand-like structures may be aggregated in bush-like forms or bushes. As used herein, the term “bushes,” and variations thereof, is intended to mean that the strand-like structures may be gathered in dense masses, and in some cases, the strands may radiate from a central area. FIG. 5 is an SEM micrograph of exemplary bushes of strand-like structures and is further described in the examples below, along with other bushes of strand-like structures.

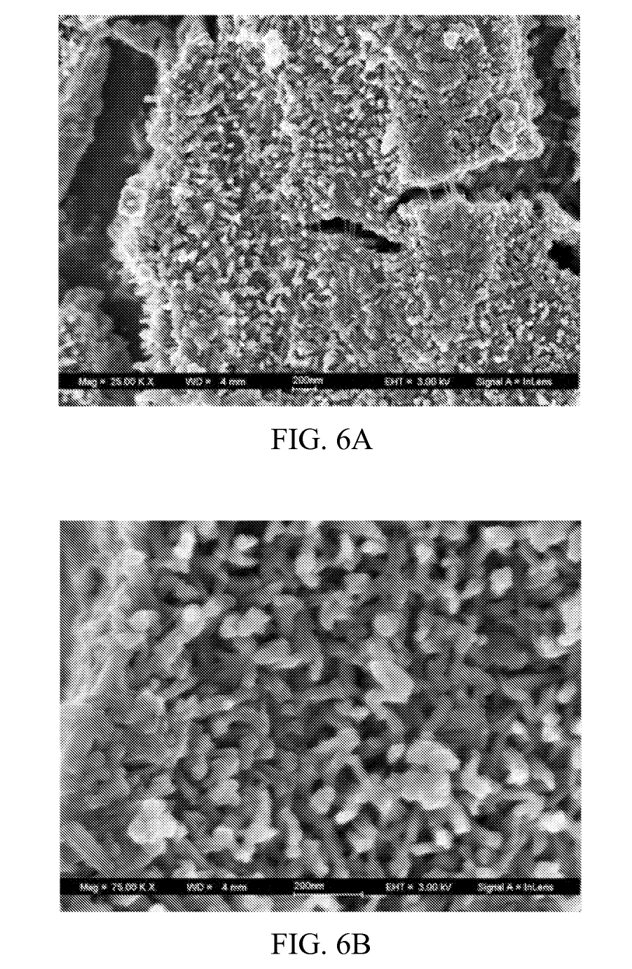

In various embodiments, the disclosure also relates to niobium nanostructures having worm-like morphology. As used herein, the term “worm-like,” and variations thereof, is intended to mean that the particles have substantially cylindrical shapes and appear disjointed or bent at various angles. The worm-like structures may cross and/or intersect. In various embodiments, the worm-like nanostructures may have a diameter of 50 nm or less. FIGS. 6a-6b are SEM micrographs of exemplary worm-like structures and are further described in the examples below.

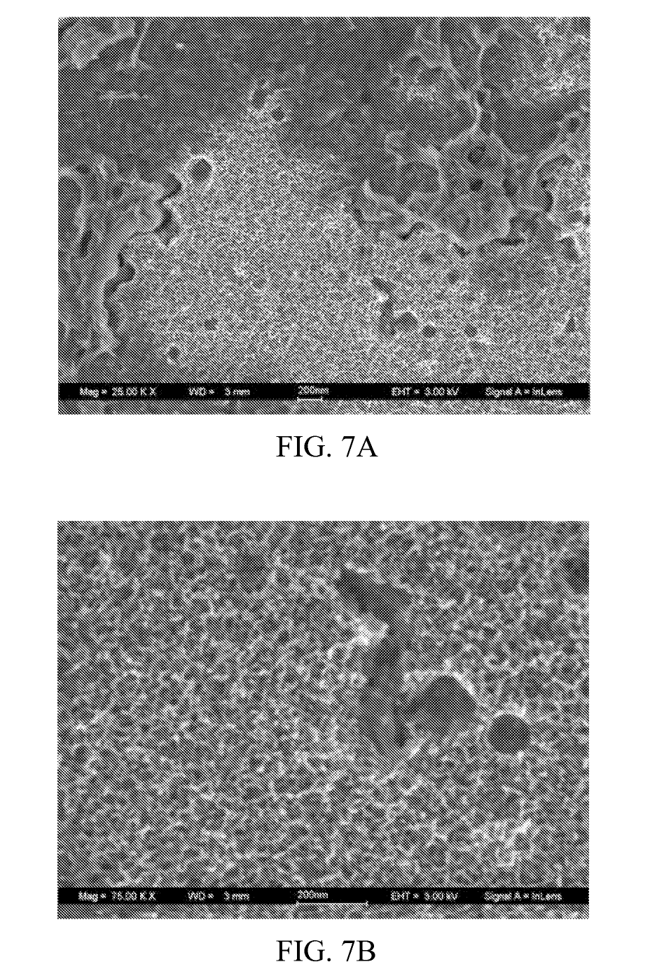

In various embodiments, the disclosure relates to materials comprising niobium nanoparticles in porous network-like structures. As used herein, the phrase “porous network-like structures,” and variations thereof, is intended to include a plurality of nano-sized particles that are at least one of fused and interconnected such that pores are formed around the particles. FIGS. 7a-7b, 8a-8b, 9a-9b, and 10a-10b are SEM micrographs of exemplary porous network-like structures and are further described in the examples below, along with other porous network-like structures.

As used herein, the term “pores,” and variations thereof, is intended to mean the voids in the porous network-like structure. In various embodiments of the disclosure, the pores may be circular or irregular. In at least some exemplary embodiments, the diameter of the pores may be 100 nm or less, for example 50 nm or less or 20 nm or less. In further embodiments, the pores may be tunnel-like and may penetrate through the thickness of the structure. The pores are shaped by the walls of the network-like structure, which are comprised of the fused and/or interconnected nanoparticles. In various embodiments, the thickness of the walls of the structure may be 50 nm or less, for example 20 nm or less or 10 nm or less.

In various embodiments, the disclosure also relates to niobium nanostructures having sphere-like morphology. As used herein, the phrase “sphere-like,” and variations thereof, is intended to include particles having a substantially spherical or ball-like shape. The shape of the sphere-like structures may be uniform or irregular, and includes oblong shapes. In various embodiments, the sphere-like structures may be aggregated to form clusters of spheres. In various embodiments, the sphere-like nanostructures may have a diameter of 100 nm or less, for example 50 nm or less or 20 nm or less. FIGS. 11a-11b are SEM micrographs of exemplary sphere-like structures and are further described in the examples below, along with other sphere-like structures.

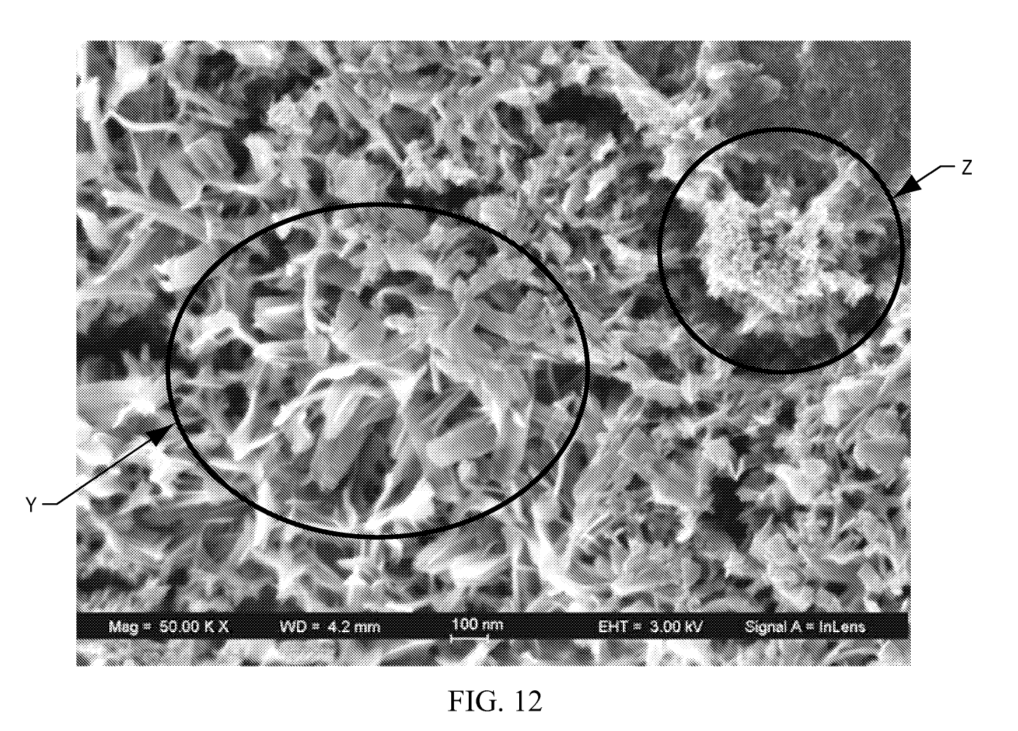

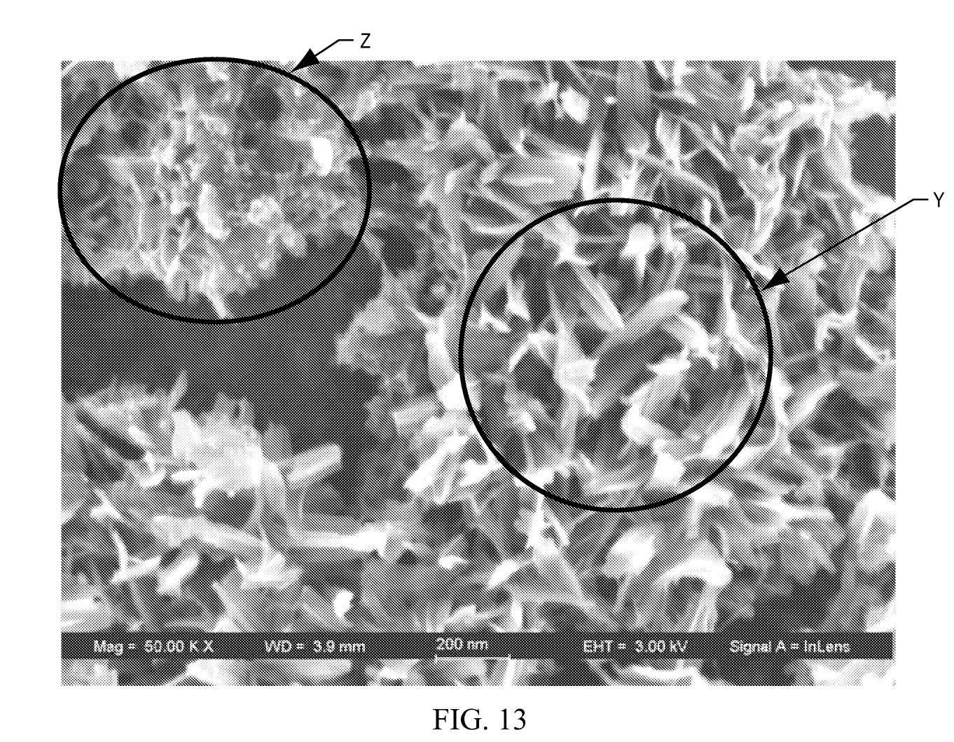

In various embodiments, the disclosure also relates to niobium nanostructures having belt-like morphology. As used herein, the term “belt-like,” and variations thereof, is intended to mean that the particles have two substantially parallel faces, forming a strip wherein the long edges are substantially parallel. In various embodiments, the belts may be substantially transparent. In various embodiments, the belt-like nanostructures may have a thickness of 50 nm or less, for example 20 nm or less or 10 nm or less. FIGS. 12 and 13 are SEM micrographs of exemplary belt-like structures and are further described in the examples below.

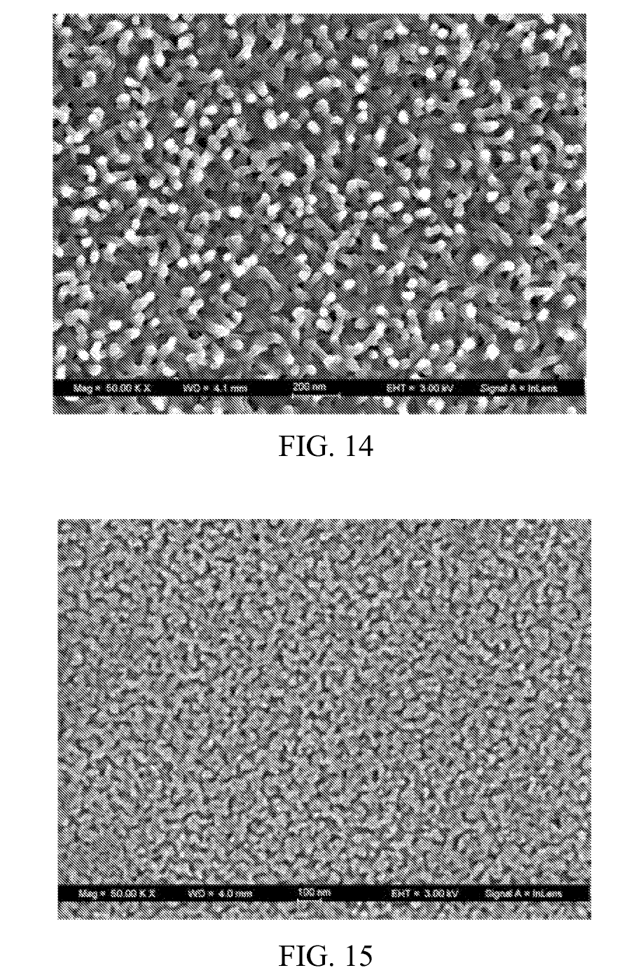

In various embodiments, the disclosure also relates to niobium nanostructures having tentacle-like morphology. As used herein, the term “tentacle-like,” and variations thereof, is intended to mean that the particles have cylindrical shapes extending from the surface and appear disjointed or bent at various angles. The tentacle-like structures may cross and/or intersect. In various embodiments, the tentacle-like nanostructures may have diameters of 100 nm or less, for example 50 nm or less or 20 nm or less. FIGS. 14 and 15 are SEM micrographs of exemplary tentacle-like structures and are further described in the examples below.

The disclosure also relates to electrochemical methods of making the nanostructures described herein. In various embodiments, the methods comprise providing an electrolytic cell, which comprises an anode and a cathode disposed in an electrolyte comprising a hydroxide, wherein the anode and cathode each comprise a surface exposed to the electrolyte; and applying an electrical potential to the electrolytic cell for a period of time sufficient to obtain nanostructures on the surface of the anode.

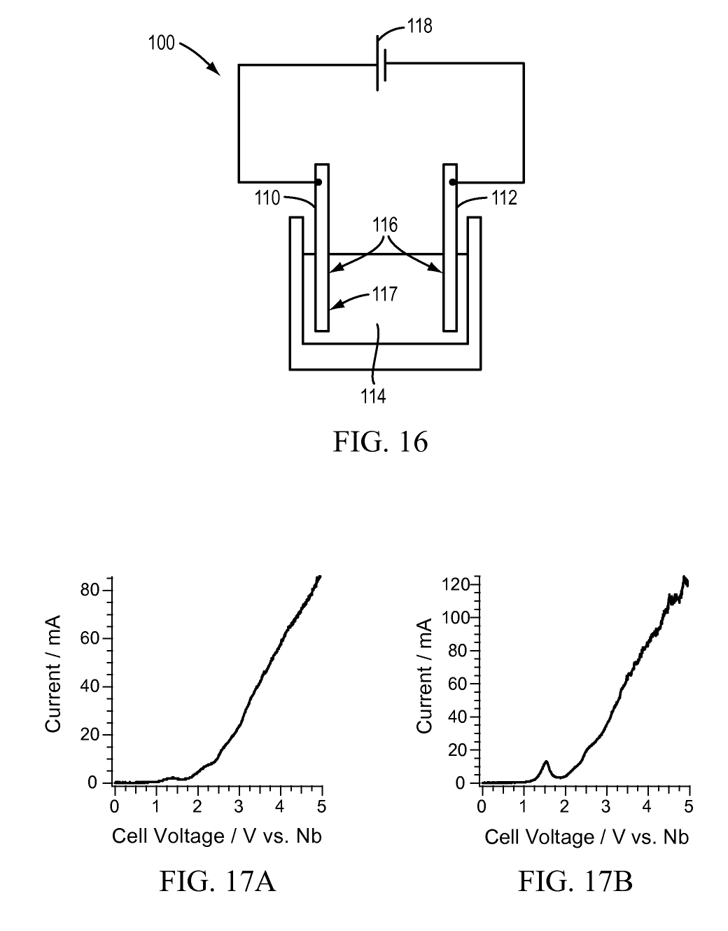

The electrolytic cells of the disclosure may be comprised of any material that is resistive to basic pH and electrically insulating. For example, in various embodiments, the electrolytic cell may be made of polytetrafluoroethylene (PTFE), which is sold commercially under the name Teflon® by DuPont of Wilmington, Del. FIG. 16 depicts an exemplary electrolytic cell 100 for use in the methods disclosed herein.

As exemplified in FIG. 16, the electrolytic cell 100 may comprise an anode 110 and a cathode 112 disposed in an electrolyte 114. In various embodiments, at least the anode comprises a surface 117 exposed to the electrolyte. According to further embodiments, the anode and the cathode may each comprise a surface 116 exposed to the electrolyte as shown in FIG. 16. The nanostructures may be obtained on the surface of an anode exposed to the electrolyte.

Reference to “a surface” or “the surface” of an anode or a cathode, and variations thereof, includes one or several surfaces of the anode or the cathode, or both the anode and the cathode, when either is exposed to the electrolyte or having nanostructures obtained thereon.

According to various embodiments, the surface of the anode comprises at least one metal selected from niobium. The surface of the anode may further comprise at least one material chosen from metal oxides, mixed metal oxides, additional metals, mixed metals, metal alloys, metal alloy oxides, and combinations thereof.

According to various embodiments, the surface of the cathode, when present, may comprise at least one material selected from metal oxides, mixed metal oxides, metals, mixed metals, metal alloys, metal alloy oxides, and combinations thereof.

In at least one embodiment, the anode and cathode may independently comprise at least one material selected from a uniform metal, a metal layer, a metal foil, a metal alloy, multiple metal layers, a mixed metal layer, multiple mixed metal layers and combinations thereof. The layer(s) may be, in various exemplary embodiments, a metal film; a mesh; a patterned layer wherein the metal(s) is/are present in strips, discrete areas, a spot, spots, and combinations thereof. An example of a mixed metal layer is a co-deposited alloy.

In one embodiment, the patterned layer may comprise only one material. In other embodiments, the pattern may comprise more than one material, and the materials may be adjacent (i.e. touching), spaced apart from one another, or any combination thereof. By way of example, a strip of metal could be next to a spot of mixed metal, which could be next to a square of metal alloy, and the strip, spot, and square could be adjacent, could be spaced apart from each other, or some combination thereof.

In another exemplary embodiment comprising layers, layers comprising the same material may be layered on top of each other. In another embodiment, different materials may be layered on top of each other, for example, one metal on top of an alloy, on top of a mixed metal, etc., with any number of combinations possible.

The metal film may be, for example, a thin film or a thick film. The metal film may comprise niobium metal. The thin film may range, for example, from a few nanometers in thickness to a few microns in thickness. The thick film may range, for example, from tens of microns in thickness to several hundreds of microns in thickness. The electrical conductivity of the surface of the metal film can facilitate electron transfer at the solid-liquid interface and the electrical connection given to the metal portion of the substrate, i.e., the anode and/or cathode. The substrate may comprise a flat or a non-flat surface. The substrate may be a flexible substrate or a substrate with a deformable surface. In at least one embodiment of the disclosure, a niobium metal film may be on the surface of at least one substrate chosen from, for example, glass and titanium.

According to various embodiments, the at least one material of the anode and/or cathode may be disposed on a conductive support, a non-conductive support, or a support that has portions that are conductive and portions that are non-conductive. In one embodiment, the anode and the cathode may comprise at least one material selected from niobium metal, niobium foil, niobium film disposed on a conductive support, niobium film disposed on a non-conductive support, and combinations thereof.

Conductive supports may, for example, comprise at least one material selected from metals, metal alloys, nickel, stainless steel, indium tin oxide (ITO), copper, and combinations thereof. In various embodiments, the conductive support may be any conductive metallic substrate. In at least one embodiment, the conductive support may be ITO.

Non-conductive supports may, for example, comprise at least one material selected from polymers, plastic, glass, and combinations thereof.

The methods of the disclosure may further comprise cleaning the substrates prior to contacting the electrolyte.

The electrolyte of the disclosure comprises at least one hydroxide. For example, the electrolyte may be a solution comprising sodium hydroxide, potassium hydroxide, and combinations thereof. The solution, in some embodiments, may be at a concentration ranging from 1 molar to 10 molar, such as, for example, ranging from 3 molar to 8 molar, for example, 5 molar.

In various embodiments, the electrolyte may further comprise at least one additive. As used herein, the term “at least one additive” includes, but is not limited materials that may modify the chemical and/or physical properties of a nanostructure. Non-limiting examples of at least one additive include boric acid, phosphoric acid, carbonic acid, sodium sulfate, potassium sulfate, sodium sulfite, potassium sulfite, sodium sulfide, potassium sulfide, sodium phosphate, potassium phosphate, sodium nitrate, potassium nitrate, sodium nitrite, potassium nitrite, sodium carbonate, potassium carbonate, sodium bicarbonate, potassium bicarbonate, a sodium halide, a potassium halide, a surfactant, and combinations thereof. When the at least one additive is a surfactant, it may be ionic, nonionic, biological, and combinations thereof.

Exemplary ionic surfactants include, but are not limited to, (1) anionic (based on sulfate, sulfonate or carboxylate anions), for example, perfluorooctanoate (PFOA or PFO), perfluorooctanesulfonate (PFOS), sodium dodecyl sulfate (SDS), ammonium lauryl sulfate, and other alkyl sulfate salts, sodium laureth sulfate (also known as sodium lauryl ether sulfate (SLES)), alkyl benzene sulfonate, soaps, and fatty acid salts; (2) cationic (based on quaternary ammonium cations), for example, cetyl trimethylammonium bromide (CTAB) (also known as hexadecyl trimethyl ammonium bromide), and other alkyltrimethylammonium salts, cetylpyridinium chloride (CPC), polyethoxylated tallow amine (POEA), benzalkonium chloride (BAC), and benzethonium chloride (BZT); and (3) zwitterionic (amphoteric), for example, dodecyl betaine, cocamidopropyl betaine, and coco ampho glycinate.

Exemplary nonionic surfactants include, but are not limited to, alkyl poly(ethylene oxide), alkylphenol poly(ethylene oxide), copolymers of poly(ethylene oxide) and poly(propylene oxide) (commercially known as Poloxamers or Poloxamines), alkyl polyglucosides, for example, octyl glucoside and decyl maltoside, fatty alcohols, for example, cetyl alcohol and oleyl alcohol, cocamide MEA, cocamide DEA, and polysorbates (commercially known as Tween 20, Tween 80), for example, dodecyl dimethylamine oxide.

Exemplary biological surfactants include, but are not limited to, micellular-forming surfactants or surfactants that form micelles in solution, for example, DNA, vesicles, and combinations thereof.

By incorporating at least one surfactant in the electrolyte, the nanostructures may become ordered, for example, by self-assembly.

In various embodiments, the at least one additive may be chosen from potassium chloride, sodium sulfate, disodium hydrogen phosphate, and boric acid.

In various embodiments, the electrolyte may further comprise at least one additional additive. The at least one additional additive may be present in conjunction with or without the at least one additive. As used herein, the term “at least one additional additive” includes, but is not limited to, a borate, a phosphate, a carbonate, a boride, a phosphide, a carbide, an intercalated alkali metal, an intercalated alkali earth metal, an intercalated hydrogen, a sulfide, a nitride, and combinations thereof. The composition of the nanostructures may, in some embodiments, be dependent on the selection of the at least one additional additive.

In various embodiments of the disclosure, the methods of making metal nanostructures comprise exposing the anode surface to the electrolyte, and applying an electrical potential to the electrolytic cell for a period of time sufficient to obtain nanostructures on the anode surface exposed to the electrolyte.

As shown in FIG. 16, the electrical potential may be applied via a power supply 118, for example, a direct current (DC) power supply, which can supply a constant voltage, or a bipotentiostat, which can supply a cyclic voltage. The potential is not limited to a constant or cyclic voltage, for example, any potential program can be used according to the method. A triangular wave, a pulsed wave, a sine wave, a staircase potential, or a saw-tooth wave are exemplary potential programs. Other applicable potential programs could be used such as other potential programs known by those skilled in the art. In various embodiments, the potential is greater than 0.0 volts, such as 0.5 volts or more. In other embodiments, the potential may be 5.0 volts or less, for example, in the range of from 0.6 volts to 5.0 volts, such as 5.0 volts or 3.0 volts. The potential, according to various embodiments, may be applied for a period of time of 30 seconds or more, for example 1 minute, 2.5 minutes, or 5 minutes. The potential, according to other embodiments may be applied for a period of time of 24 hours or less. By way of example, the potential may be applied for a period of time ranging from 30 minutes to 24 hours, for example, for 2 hours to 16 hours, such as 30 minutes, 2 hours, 6 hours or 16 hours.

One or more nanostructures may be obtained by the methods described herein. By way of example, when a surface exposed to the electrolyte comprises a metal, a mixed metal, and/or a metal alloy, the metal or metals could be converted to an oxide or a hydroxide, or could remain a metal. For example, all of the metals, one or more of the metals, or none of the metals could be converted to an oxide or hydroxide, or any combination thereof. In various embodiments, at least one metal remains a metal. In a further embodiment, the at least one metal may be niobium, and the niobium may remain niobium. Conversion of the metal(s) to an oxide or a hydroxide, or lack thereof, may be dependent upon the specific starting material, for example, dependent upon the material's electrochemical behavior when exposed to the electrolyte.

In further exemplary embodiments, when a surface exposed to the electrolyte comprises a metal oxide, a mixed metal oxide, or a metal alloy oxide, the metal oxide may be converted to a metal or a hydroxide. Conversion of the metal oxides to a metal or a hydroxide may be dependent upon the specific starting material, for example, dependent upon the material's electrochemical behavior when exposed to the electrolyte. In further embodiments, the metal oxides may remain oxides but the stoichiometry may change. For example, in the case of cobalt oxide, when a surface comprises CoO, after electrochemical processing the composition of the nanostructures can remain CoO, can be converted to CO₃O₄, can be converted to Co, or combinations thereof.

The nanostructures obtained by the methods described herein may have one or more particle structure or morphology. By way of example, the niobium nanostructures of the disclosure may comprise porous network-like structures, strand-like morphology, worm-like, sphere-like, belt-like and tentacle-like morphology. In various embodiments, the strand-like structures may be aggregated in webs or bushes.

In various embodiments, the methods described herein may be carried out at ambient conditions, for example, room temperature and atmospheric pressure, and may utilize low voltage and current, thus, lower energy. In other embodiments, the method may further comprise heating the electrolyte to a temperature of from 15° C. to 80° C., for example, from 30° C. to 80° C., for example, from 30° C. to 60° C., such as 40° C. or 60° C. Heating the electrolyte may be accomplished by a number of heating methods known in the art, for example, a hot plate placed under the electrolytic cell. In various embodiments, the temperature may be adjusted depending on desired nanostructures and materials used. Appropriate heating temperature, if any, is within the ability of those skilled in the art to determine.

In one embodiment, the method may further comprise agitating the electrolyte. Any number of agitation methods known in the art may be used to agitate the electrolyte, for example, a magnetic stirring bar placed in the electrolyte with a stirrer placed under the electrolytic cell. Mechanical stirring or ultrasonic agitation, for example, may also be used. Appropriate conditions (e.g. stirring rate) for agitation, if any, are within the ability of those skilled in the art to determine.

According to one embodiment, the method may further comprise cleaning the anode after obtaining the nanostructures. The cleaning, in some embodiments, may comprise acid washing. The acid may be selected from hydrochloric, sulfuric, nitric, and combinations thereof.

In one embodiment, the method comprises making the nanostructures in a batch process. In another embodiment, the method comprises making the nanostructures in a continuous process.

For example, in various embodiments, the process may be a batch process where sheets niobium substrates may be immersed in the electrolyte (such as NaOH or KOH) and nanostructures created by applying an electric potential.

Other exemplary embodiments may include a continuous process wherein two niobium substrate rolls are fed (e.g. continuously) into a tank containing electrolyte (such as NaOH or KOH) while electric potential is being applied. A downstream cleaning and/or rinsing step may optionally be integrated producing rolls of niobium nanostructured surfaces.

In various embodiments described herein, the reaction may be limited to the surface that is in contact with the electrolyte, allowing for improved or otherwise satisfactory process control.

In various embodiments, the process may be monitored by monitoring the current as a function of time.

The niobium nanostructures of the disclosure may be used in various applications, including, but not limited to, photovoltaic energy conversion and photocatalysis, photooxidation of organic pollutants, memory switching, electrochromic devices, ferroelectric devices, sensing (such as oxygen sensors and ammonia sensors), catalyst for trans-esterification of β-keto esters with alcohols, label-free detection of DNA hybridization events, DNA biosensors, and osteoblast cell adhesion.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the nanostructure” or “nanostructure” is intended to mean at least one nanostructure.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLES

### Example 1

99.98% niobium foils of 0.25 nm thickness, available from Alfa Aesar of Ward Hill, Mass., were cut to size and cleaned by sonication in a 1:1:1 mixture of acetone, iso-propanol, and deionized (DI) water for 15 minutes. The niobium foils were then rinsed in DI water and further sonicated in DI water for 15 minutes. The niobium foils were dried under a stream of nitrogen.

The electrolyte was prepared using certified ACS sodium hydroxide and certified ACS potassium hydroxide, all available from Alfa Aesar, in DI water.

Electrolytic cells, for example, electrochemical cells of different sizes (1.5″×1″×1″, 3″×1.5″×3.5″ and 6″×3″×7″ internal dimensions) were made using Teflon.

A bipotentiostat, model AFRDE5, available from PINE Instrument Company of Grove City, Pa., was used to perform cyclic voltammetry methods. Constant voltage methods were performed using a DC power supply, Model E36319, available from Agilent of Santa Clara, Calif. In the examples, similarly sized niobium foils were used as both the anode and the cathode surfaces.

FIGS. 17a and 17b show the anodic scan of the cyclic voltammetry of a niobium substrate in 5 molar (M) NaOH and KOH electrolytes, respectively.

As shown in FIG. 17a, at potentials less than 1.0 volts (V) in the NaOH electrolyte, near zero current is observed. As the potential is increased beyond 1.0V, the substrate current increases with several local maxima. At potentials greater than 2.5V, the current increases continuously, indicating a kinetically limited electron-transfer reaction.

FIG. 17b shows the cyclic voltammetry of a niobium substrate in 5M KOH. The niobium electrode exhibits similar (but not identical) behavior to the NaOH electrolyte (FIG. 17a). At potentials less than 1.2V, near zero current is observed. As the potential is increased beyond 1.2V, small peak is observed at 1.5V. The substrate current increases continuously beyond 2.0V, indicating a kinetically limited electron-transfer reaction.

The cyclic voltammetry may be used as a guide for predictive experimentation, i.e., the potential to be applied can be chosen to influence reaction-specific changes to the surface of the anode. Based on the cyclic voltammetry of the niobium electrodes, it was decided to run the experiments at a voltage of 5V as it eliminates any diffusion limitation during experimentation.

The experimental set up shown in FIG. 16 was used, and pre-cleaned niobium foils (anodes and cathodes) were placed vertically against opposing faces of a Teflon® cell and the cell was filled with an electrolyte (NaOH or KOH). The foils were then connected to a DC power supply, which applied a preset voltage across the two foils, now electrodes. After subjecting the foils/electrodes to the electrochemical potential, the anode and cathode electrodes were acid washed in 1M HCl to remove any NaOH or KOH left behind by the electrochemical experiments. Several examples were performed by systematically changing various experimental conditions as set forth in Table 1, and the results are discussed below.

TABLE 1
Example 1 Conditions

| | Electrolyte | | |
|---|---|---|---|
| Sample ID | (5M) | Time (h) | Temp (° C.) |
| 1A | NaOH | 0.5 | 20 |
| 1B | NaOH | 2 | 20 |
| 1C | NaOH | 6 | 20 |
| 1D | NaOH | 16 | 20 |
| 1E | NaOH | 2 | 40 |
| 1F | KOH | 0.5 | 20 |
| 1G | KOH | 2 | 20 |
| 1H | KOH | 6 | 20 |
| 1J | KOH | 16 | 20 |
| 1K | KOH | 2 | 40 |

### Sample 1A

FIGS. 1a-1d show the scanning electron microscope (SEM) micrographs of the niobium foil subject to the conditions set forth for sample 1A in Table 1. No discernable structures were observed on the cathode. All SEM micrographs and discussion henceforth relate to only the anode.

Nanometer sized structures were observed on the surface of the anode, including some features that are less than 10 nm. FIGS. 1a-1d show the anode at magnifications of 500×, 25,000×, 50,000×, and 75,000×, respectively. The images show strand-like nanostructures of niobium aggregated in a webbed form with high surface area and uniformity. Some of the strand-like structures appear transparent. The nanostructures cover the surface of the anode, rather than forming islands of nanostructures.

### Sample 1B

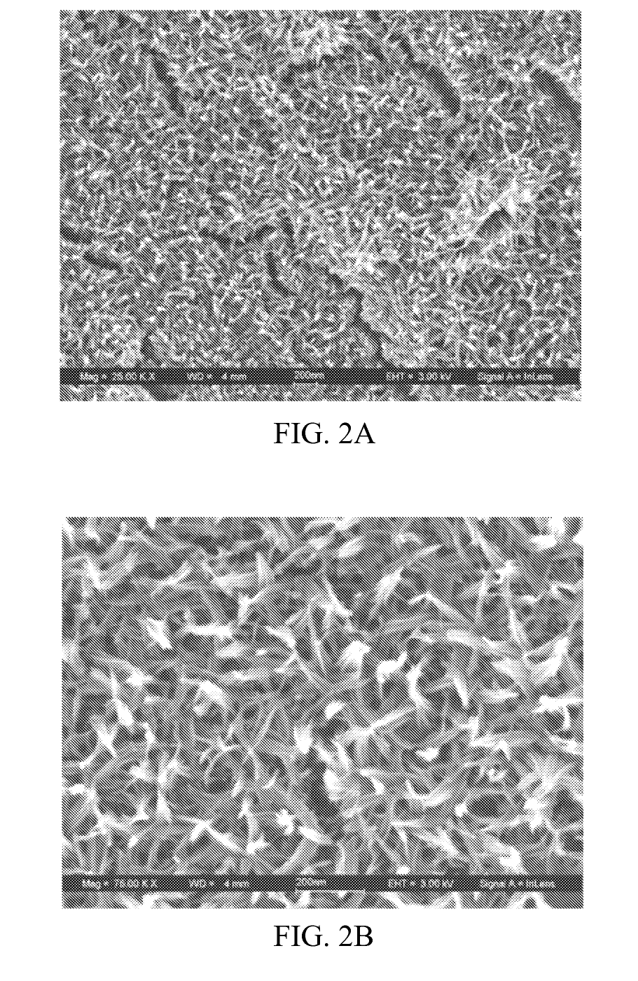

FIGS. 2a-2b show the SEM micrographs of the niobium foil subject to the conditions set forth for sample 1B in Table 1. As with sample 1A, strand-like nanostructures of niobium aggregated in a web form were observed on the surface of the anode. FIGS. 2a-2b show the anode at magnifications of 25,000× and 75,000×, respectively. While these images still show high surface area and uniformity for the nanostructures, cracks on the surface are observed in FIG. 2a.

Additionally, optical images show that the niobium nanostructures are green in color.

### Sample 1C

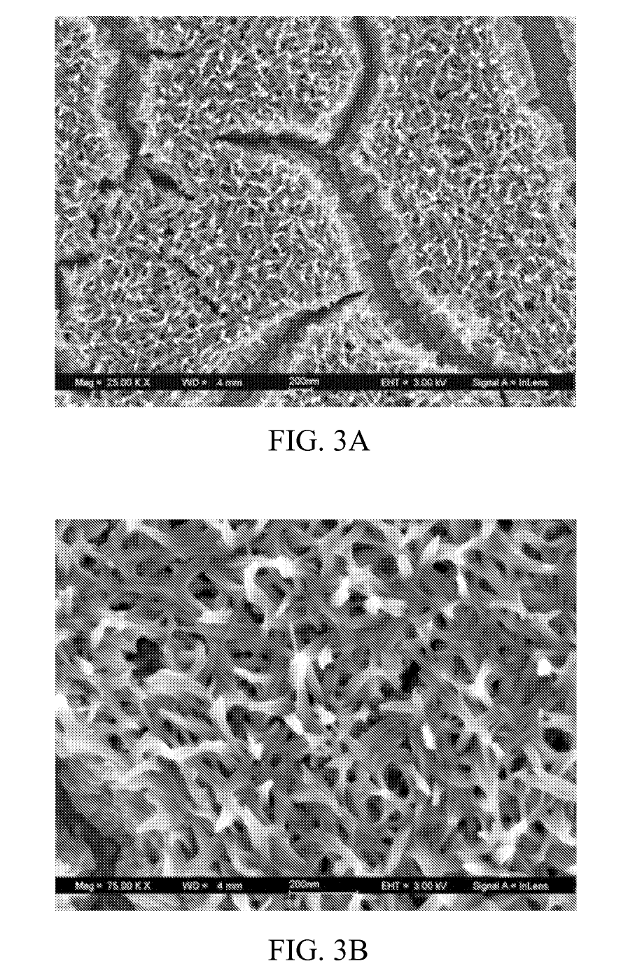

FIGS. 3a-3b show the SEM micrographs of the niobium foil subject to the conditions set forth for sample 1C in Table 1. As with samples 1A and 1B, strand-like nanostructures of niobium aggregated in a webbed form were observed on the surface of the anode. FIGS. 3a-3b show the anode at magnifications of 25,000× and 75,000×, respectively. FIG. 3a shows the formation of cracks on the surface, and FIG. 3b shows that the strands are more well-defined than in samples 1A and 1B.

### Sample 1D

FIGS. 6a-6b show the SEM micrographs of the niobium foil subject to the conditions set forth for sample 1D in Table 1. Unlike samples 1A, 1B, and 1C, which also used NaOH, worm-like nanostructures are formed. The structures appear as though the strands seen in previous samples collapsed into pillared, worm-like structures. FIGS. 6a-6b show the anode at magnifications of 25,000× and 75,000×, respectively. FIG. 6b shows that the structures have a high surface area, as in previous samples. FIG. 6a shows the formation of large cracks on the surface.

### Sample 1E

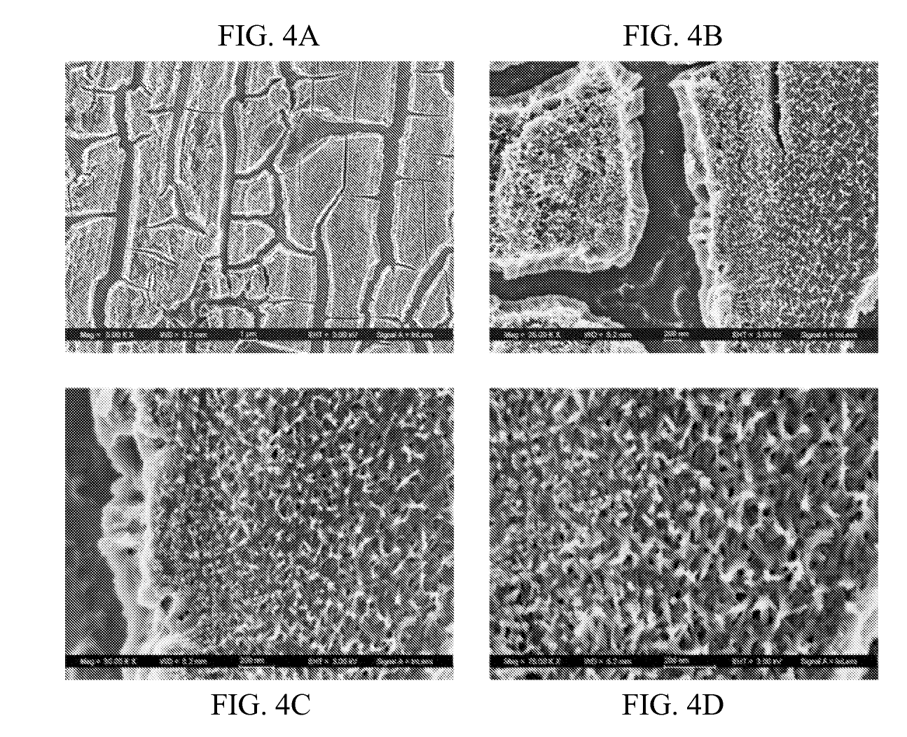

FIGS. 4a-4d show the SEM micrographs of the niobium foil subject to the conditions set forth for sample 1E in Table 1. As with samples 1A, 1B, and 1C, strand-like nanostructures of niobium aggregated in a web form were observed on the surface of the anode. FIGS. 3a-3d show the anode at magnifications of 500×, 25,000×, 50,000× and 75,000×, respectively. FIGS. 4c and 4d show that the strands are densely packed, and FIGS. 4a and 4b shows the formation of large cracks on the surface.

### Sample 1F

FIGS. 7a-7b show the SEM micrographs of the niobium foil subject to the conditions set forth for sample 1F in Table 1. Porous network-like structure with circular pores formed on the anode. FIGS. 7a-7b show the anode at magnifications of 25,000× and 75,000×, respectively. FIG. 7a shows that the nanostructures formed in islands, i.e., not uniformly across the surface.

### Sample 1G

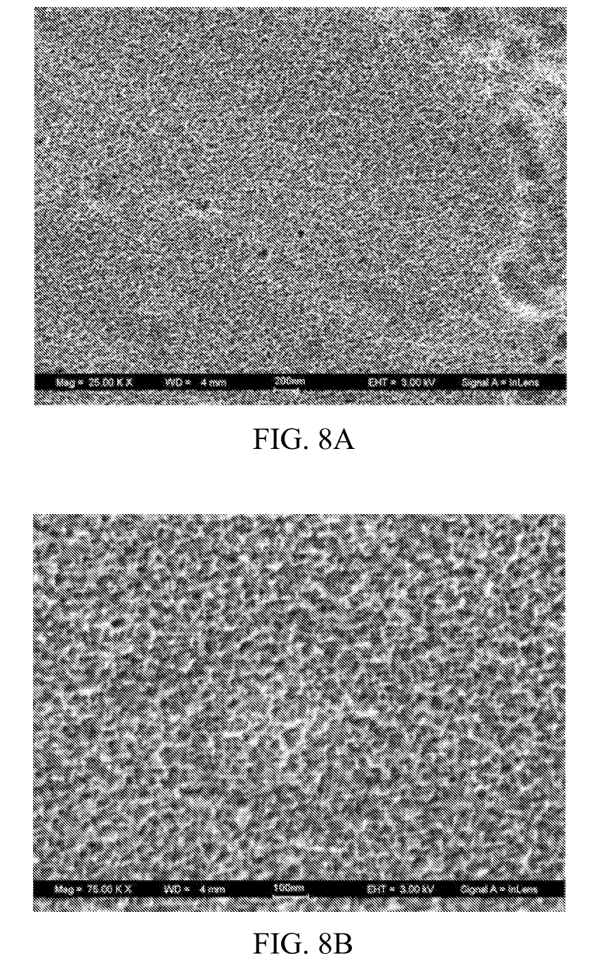

FIGS. 8a-8b show the SEM micrographs of the niobium foil subject to the conditions set forth for sample 1G in Table 1. Like sample 1F, porous network-like structure with circular pores formed on the anode. FIGS. 8a-8b show the anode at magnifications of 25,000× and 75,000×, respectively. FIG. 8a shows that the nanostructures formed more uniformly than in sample 1F. FIG. 8b shows that the thickness of some pore walls is less than 10 nm. The porous structure has a high surface area to volume ratio, indicating that it would allow high rates of mass transfer.

Additionally, optical images show that the niobium nanostructures are blue in color.

### Sample 1H

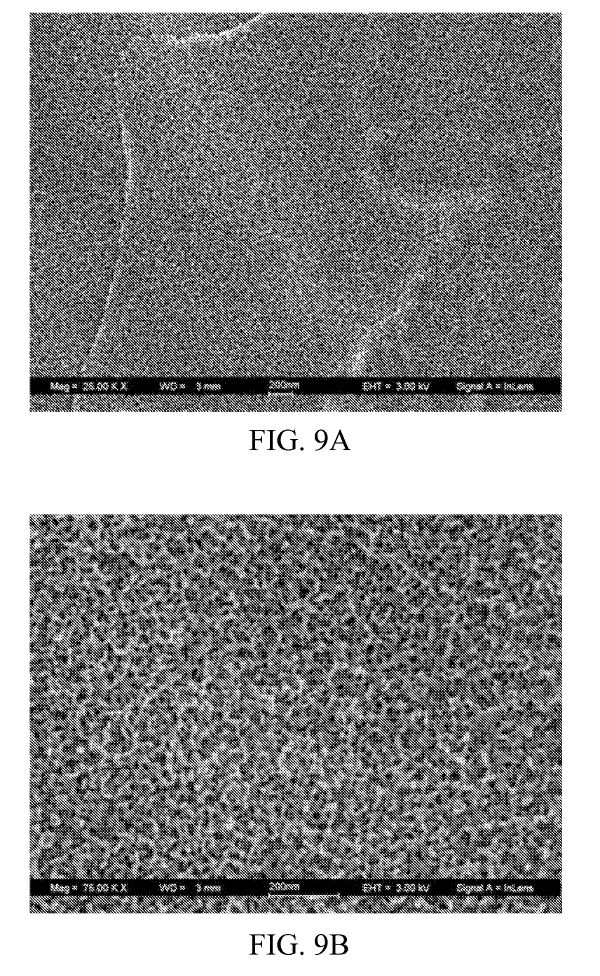

FIGS. 9a-9b show the SEM micrographs of the niobium foil subject to the conditions set forth for sample 1H in Table 1. Like samples 1F and 1G, porous network-like structure with circular pores formed on the anode. FIGS. 9a-9b show the anode at magnifications of 25,000× and 75,000×, respectively. FIG. 9a shows that the nanostructures formed uniformly across the surface. While the pores and pore walls are still in the size range of less than 10 nm, FIG. 9b shows that some of the pore walls have thickened and the pore sizes have decreased relative to sample 1G.

### Sample 1J

FIGS. 11a-11b show the SEM micrographs of the niobium foil subject to the conditions set forth for sample 1J in Table 1. Sphere-like nanostructures have formed on the anode. FIGS. 11a-11b show the anode at magnifications of 25,000× and 75,000×, respectively. FIG. 11a shows that the nanostructures are uniformly distributed on the surface.

### Sample 1K

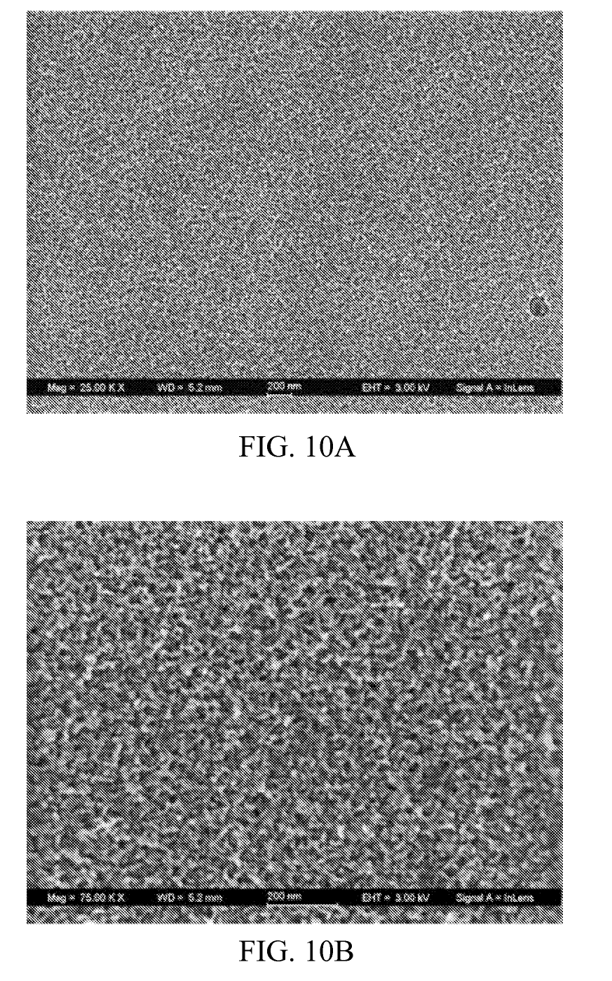

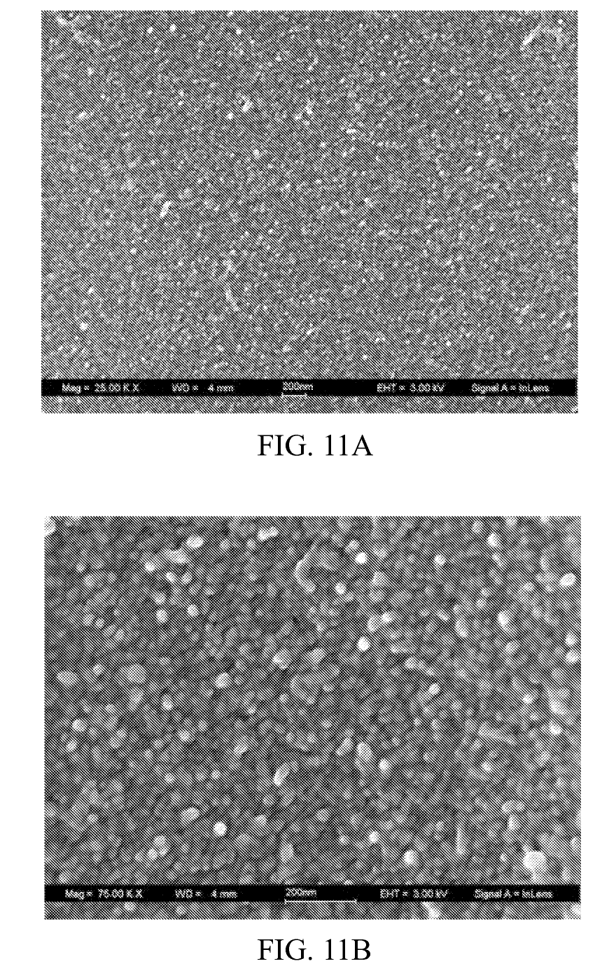

FIGS. 10a-10b show the SEM micrographs of the niobium foil subject to the conditions set forth for sample 1K in Table 1. Like samples 1F, 1G, and 1H, porous network-like structure with circular pores formed on the anode. FIGS. 10a-10b show the anode at magnifications of 25,000× and 75,000×, respectively. FIG. 10a shows that the nanostructures formed uniformly across the surface. In FIG. 10b, the pores appear densely packed, but the pores and pore walls again appear to be in the size range of less than 10 nm.

It is apparent from the results of Example 1 that one could adjust the experimental conditions to obtain desired nanostructures. For example, if porous structures are desired (similar to the ones observed in the sample described herein), a KOH electrolyte may be desirable.

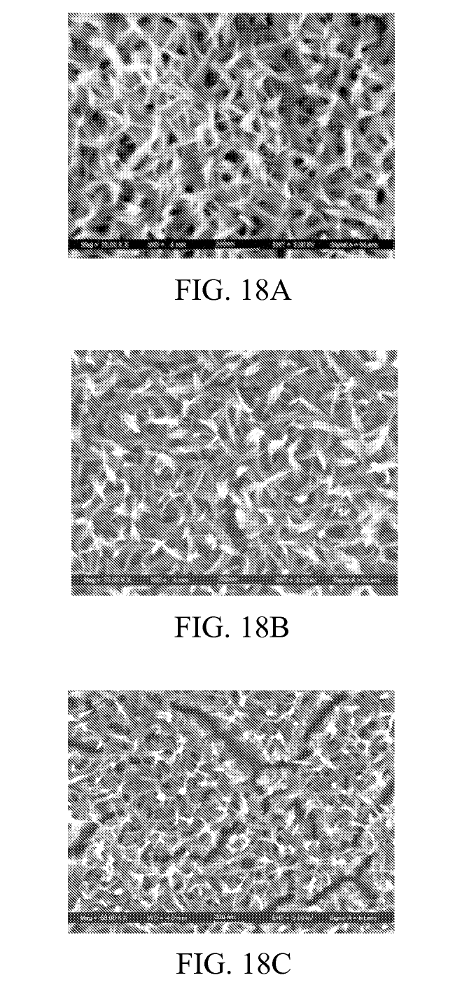

Additionally, three samples were run under the same conditions as sample 1B on niobium foils of varying sizes: (a) 20 mm×50 mm; (b) 40 mm×100 mm; and (c) 100 mm×200 mm. FIGS. 18a-18b show the SEM micrographs taken from the anode surfaces at 75,000× magnification for foil sizes (a) and (b) respectively, and FIG. 18c shows the SEM micrograph taken at 50,000× magnification for foil size (c). As can be seen from FIGS. 18a-18c, strand-like nanostructures of niobium aggregated in a web form with high surface area and uniformity in all three cases regardless of substrate size.

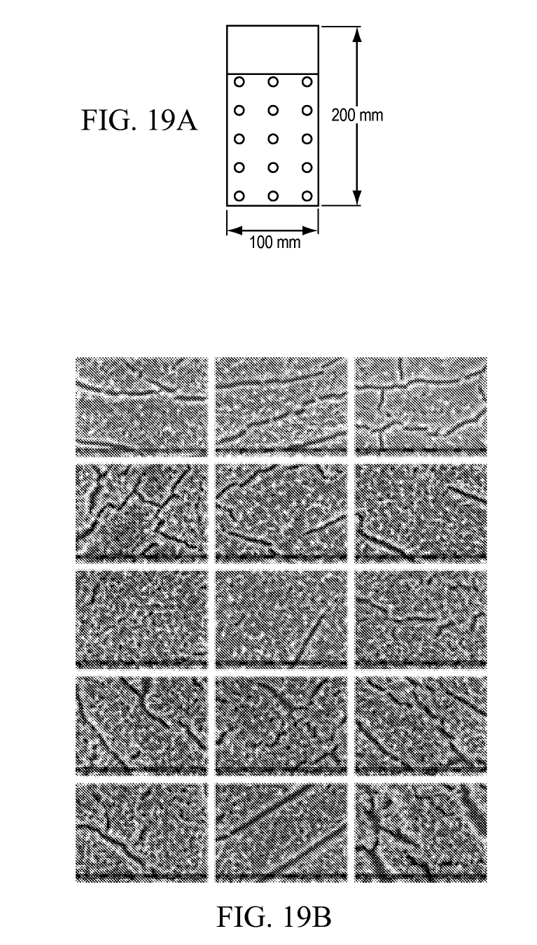

To further study uniformity of the nanostructures across the surface, FIG. 19a shows a schematic of a substrate with the white circles being the portions that were punched out and sampled. FIG. 19b shows the SEM micrographs of the various regions sampled. The order of the images corresponds with the order of the white circles in FIG. 19a. FIG. 19b shows that the entire surface is comprised of the same nanostructures. One exception to this may be the topmost row, which shows slightly less density of the nanostructures. This may be due to the proximity to the air-liquid interface, where such non-uniformities may be expected, and could be rectified with conventional techniques.

### Example 2

Additional experiments were performed using the same type of niobium foils and experimental set up as described in Example 1. In this series of experiments, niobium foils/electrodes were subjected to an electrochemical potential of 5V in a 5M electrolyte solution at room temperature. The composition of the solution varied for each sample as set forth in Table 2 below, along with the time.

TABLE 2
Example 2 Conditions

| | NaOH:KOH | |
|---|---|---|
| Sample ID | ratio | Time (h) |
| 2A | 100:0 | 0.5 |
| 2B | 75:25 | 0.5 |
| 2C | 50:50 | 0.5 |
| 2D | 25:75 | 0.5 |
| 2E | 0:100 | 0.5 |
| 2F | 100:0 | 2.0 |
| 2G | 75:25 | 2.0 |
| 2H | 50:50 | 2.0 |
| 2J | 25:75 | 2.0 |
| 2K | 0:100 | 2.0 |

### Sample 2A

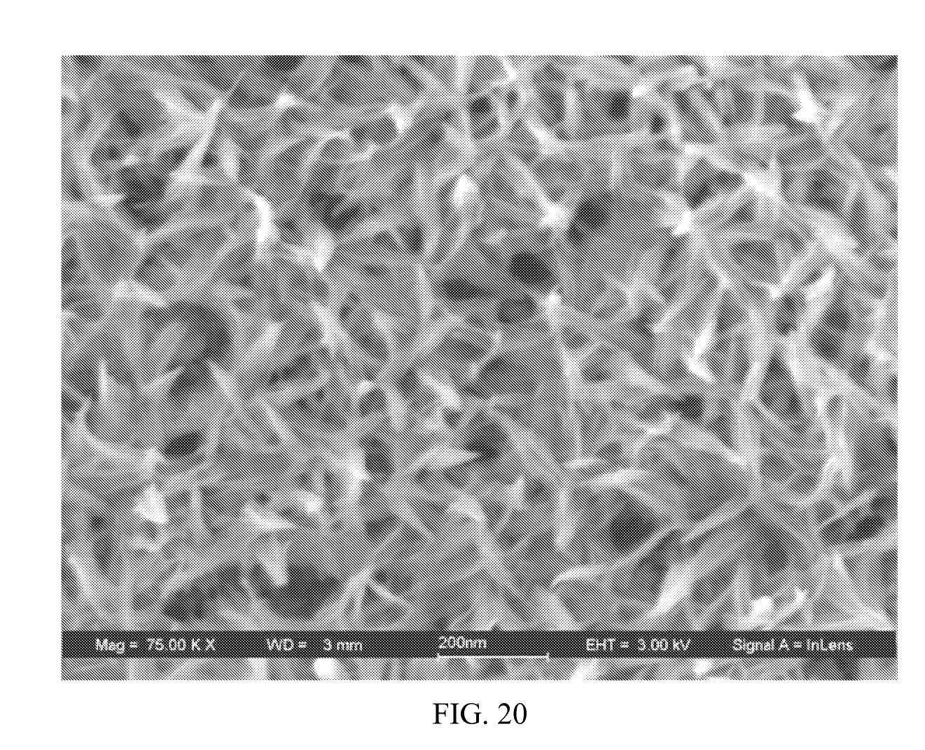

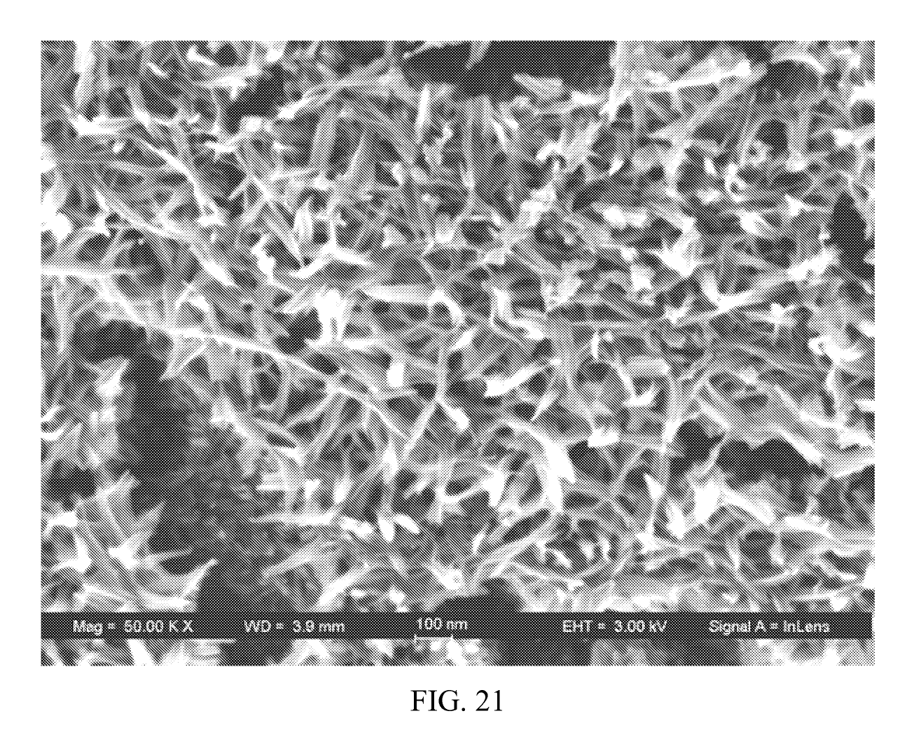

FIG. 20 shows the SEM micrograph of the niobium foil subject to the conditions set forth for sample 2A in Table 2. Nanometer sized structures were observed on the surface of the anode. FIG. 20 shows the anode at a magnification of 75,000×, and the image shows strand-like nanostructures of niobium aggregated in a web form with high surface area and uniformity. Some of the strand-like structures appear transparent. The nanostructures appear to cover the surface of the anode, rather than forming islands of nanostructures.

### Sample 2B

FIG. 21 shows the SEM micrograph of the niobium foil subject to the conditions set forth for sample 2B in Table 2. Like sample 2A, nanometer sized structures were observed on the surface of the anode. FIG. 20 shows the anode at a magnification of 75,000×, and the image shows strand-like nanostructures of niobium aggregated in a web form with high surface area and uniformity. The nanostructures appear more defined than in sample 2A, and the surface appears to have cracks and be less uniform that sample 2A.

### Sample 2C

FIG. 5 shows the SEM micrograph of the niobium foil subject to the conditions set forth for sample 2C in Table 2. Strand-like nanostructures gathered in dense, bush-like masses were observed. FIG. 5 shows the anode at a magnification of 75,000×.

### Sample 2D

FIG. 12 shows the SEM micrograph of the niobium foil subject to the conditions set forth for sample 2D in Table 2. Belt-like nanostructures (Y) and porous network-like structures (Z) were observed on the surface. FIG. 12 shows the anode at a magnification of 75,000×, and it is observed that the surface is non-uniform.

### Sample 2E

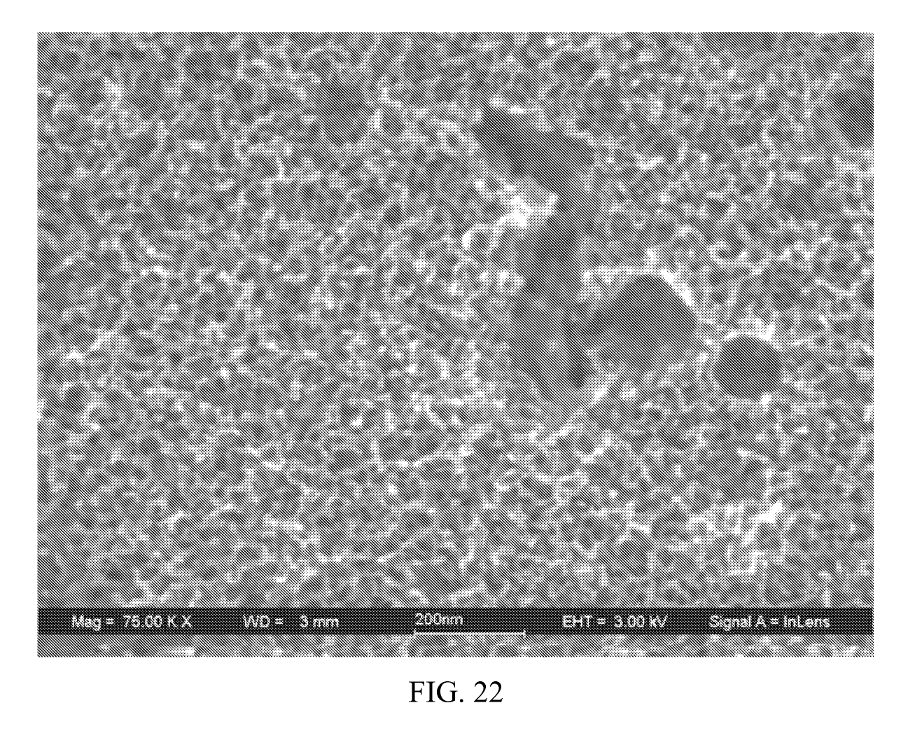

FIG. 22 shows the SEM micrograph of the niobium foil subject to the conditions set forth for sample 2E in Table 2. Porous network-like structures with circular pores formed on the anode. FIG. 22 show the anode at a magnification of 75,000× and shows that the nanostructures formed somewhat uniformly.

### Sample 2F

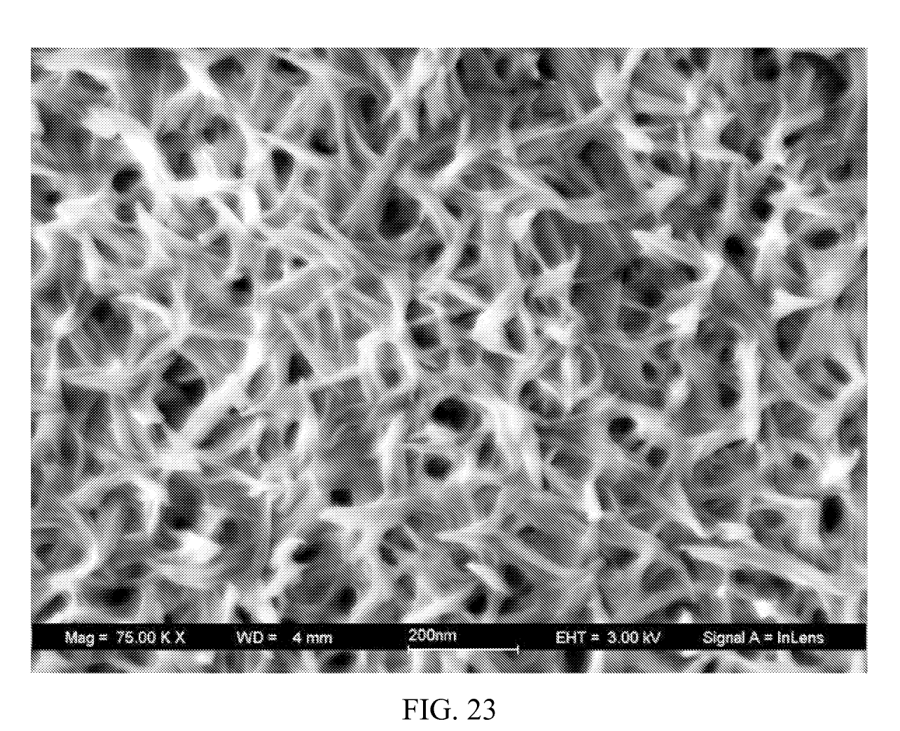

FIG. 23 shows the SEM micrograph of the niobium foil subject to the conditions set forth for sample 2F in Table 2. Like sample 2A, FIG. 23 shows the anode at a magnification of 75,000×, and the image shows strand-like nanostructures of niobium aggregated in a web form with high surface area and uniformity. Some of the strand-like structures appear transparent. The nanostructures appear to cover the surface of the anode, rather than forming islands of nanostructures.

### Sample 2G

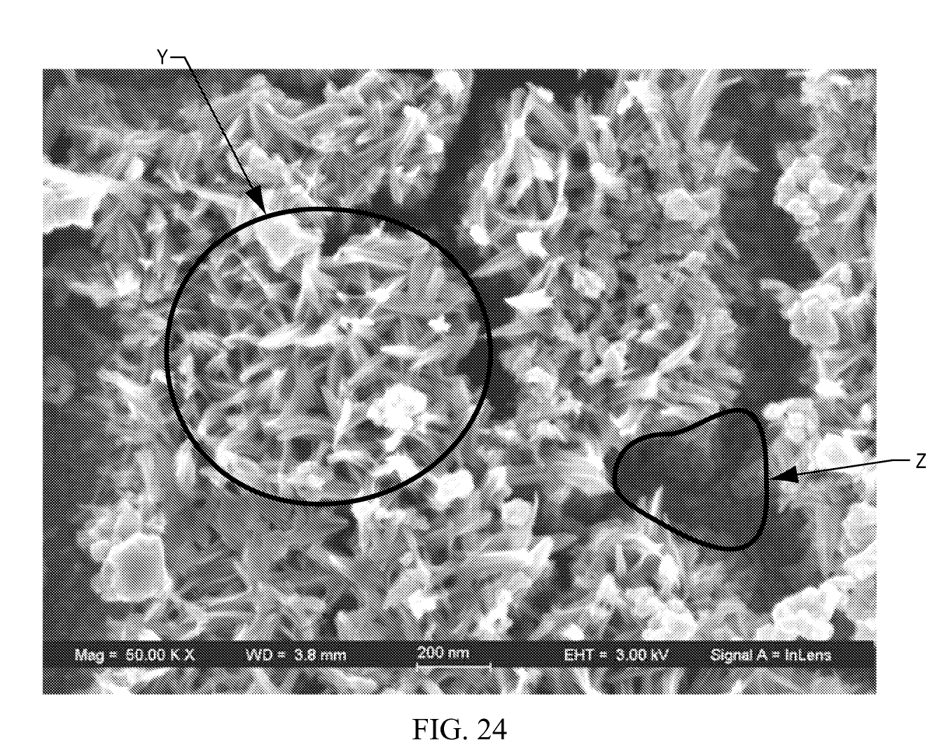

FIG. 24 shows the SEM micrograph of the niobium foil subject to the conditions set forth for sample 2G in Table 2. In FIG. 24, the anode is at a magnification of 75,000× and shows strand-like nanostructures gathered in dense, bush-like masses (Y). FIG. 24 also shows porous network-like structures with circular pores formed on the anode (Z).

### Sample 2H

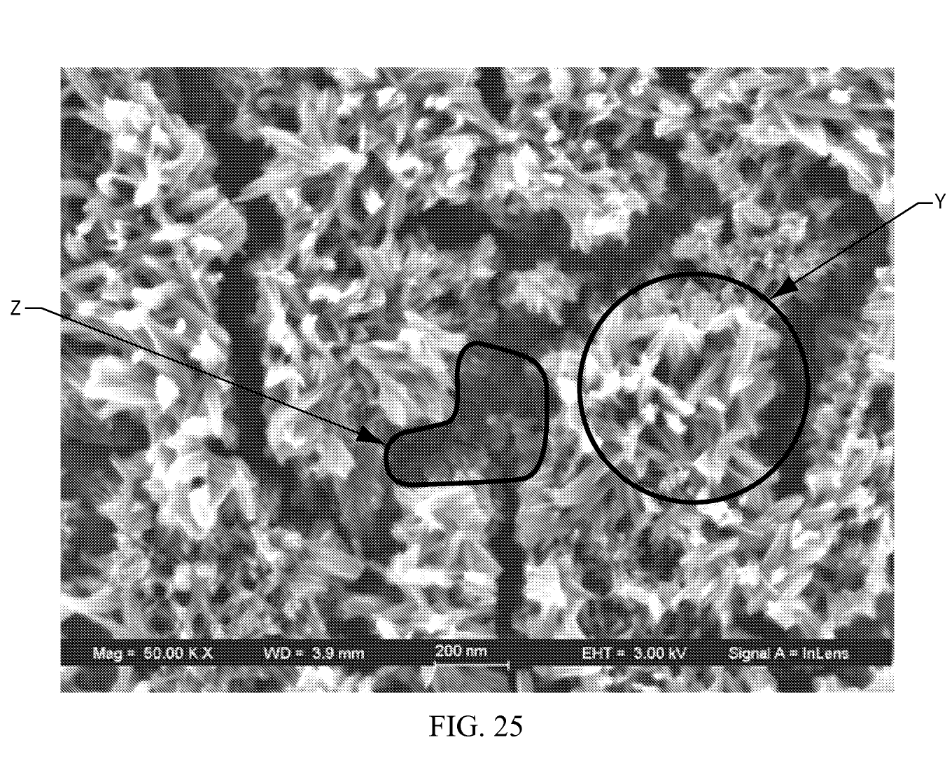

FIG. 25 shows the SEM micrograph of the niobium foil subject to the conditions set forth for sample 2H in Table 2. In FIG. 25, the anode is at a magnification of 75,000× and shows strand-like nanostructures gathered in dense, bush-like masses (Y). FIG. 25 also shows porous network-like structures with circular pores formed on the anode (Z).

### Sample 2J

FIG. 13 shows the SEM micrograph of the niobium foil subject to the conditions set forth for sample 2J in Table 2. Belt-like nanostructures (Y) and porous network-like structures (Z) were observed on the surface. FIG. 13 shows the anode at a magnification of 75,000×, and it is observed that the surface is non-uniform.

### Sample 2K

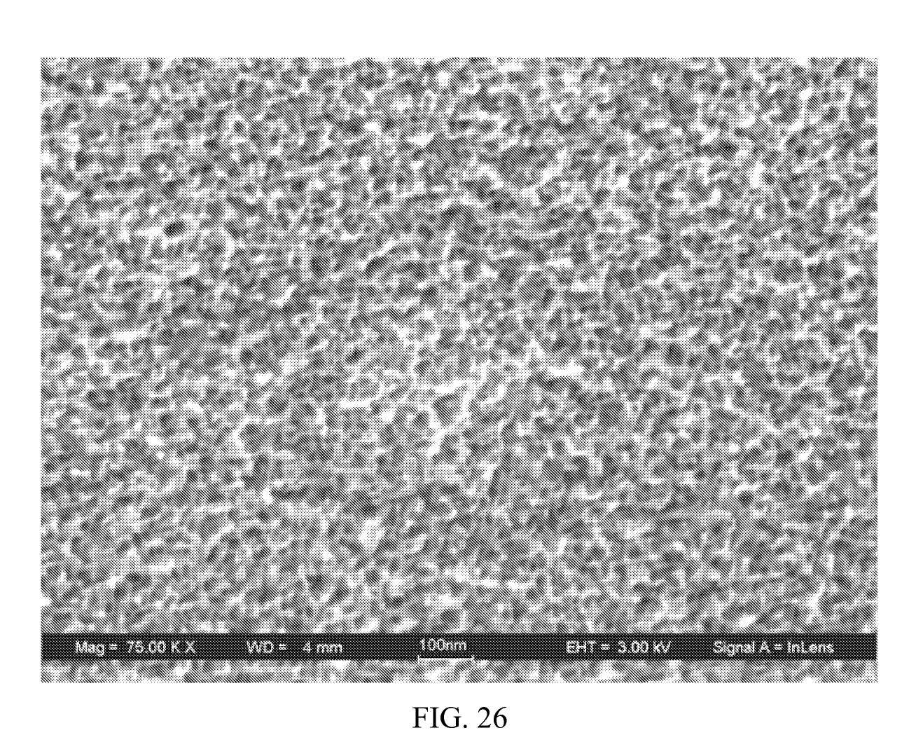

FIG. 26 shows the SEM micrograph of the niobium foil subject to the conditions set forth for sample 2K in Table 2. Porous network-like structures with circular pores formed on the anode. FIG. 26 show the anode at a magnification of 75,000×, and shows that the nanostructures formed somewhat uniformly.

### Example 3

Additional experiments were performed using the same type of niobium foils and experimental set up as described in Examples 1 and 2. In this series of experiments, niobium foils/electrodes were subjected to an electrochemical potential of 5V in a 5M electrolyte solution at room temperature for 2 hours. In this example, additives at a concentration to 1000 ppm each were used in the electrolytes, and the compositions of the electrolytes are set forth in Table 3 below.

TABLE 3
Example 3 Electrolyte Solutions

| Sample ID | Electrolyte | Additive |
|---|---|---|
| 3A | NaOH | KCl |
| 3B | NaOH | Na₂SO₄ |
| 3C | NaOH | Na₂HPO₄ |
| 3D | NaOH | H₃BO₃ |
| 3E | KOH | KCl |
| 3F | KOH | Na₂SO₄ |
| 3G | KOH | Na₂HPO₄ |
| 3H | KOH | H₃BO₃ |

### Sample 3A

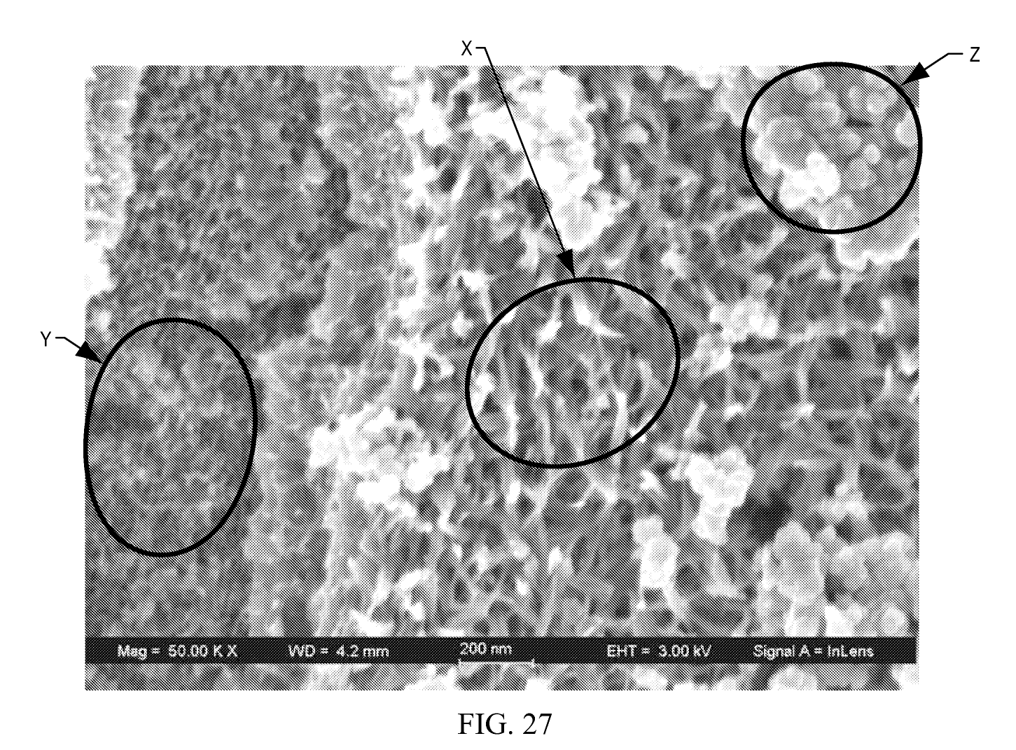

FIG. 27 shows the SEM micrograph of the niobium foil subject to the conditions set forth for sample 3A in Table 3. At least three different nanostructures are shown in FIG. 27, which is the anode is at a magnification of 75,000×. Webbed strand-like nanostructures (X) are observed, as are porous network-like structures with circular pores (Y) and sphere-like structures (Z), which are aggregated.

### Sample 3B

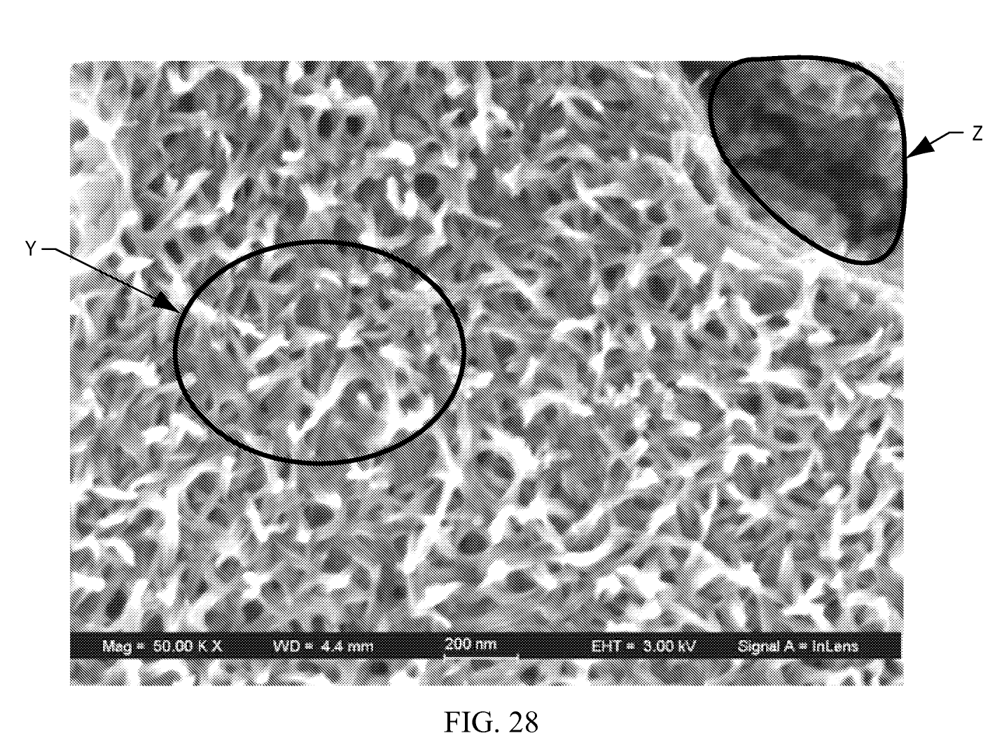

FIG. 28 shows the SEM micrograph of the niobium foil subject to the conditions set forth for sample 3B in Table 3. In FIG. 28, the anode is at a magnification of 75,000× and shows webbed strand-like nanostructures (Y). FIG. 28 also shows porous network-like structures with circular pores (Z).

### Sample 3C

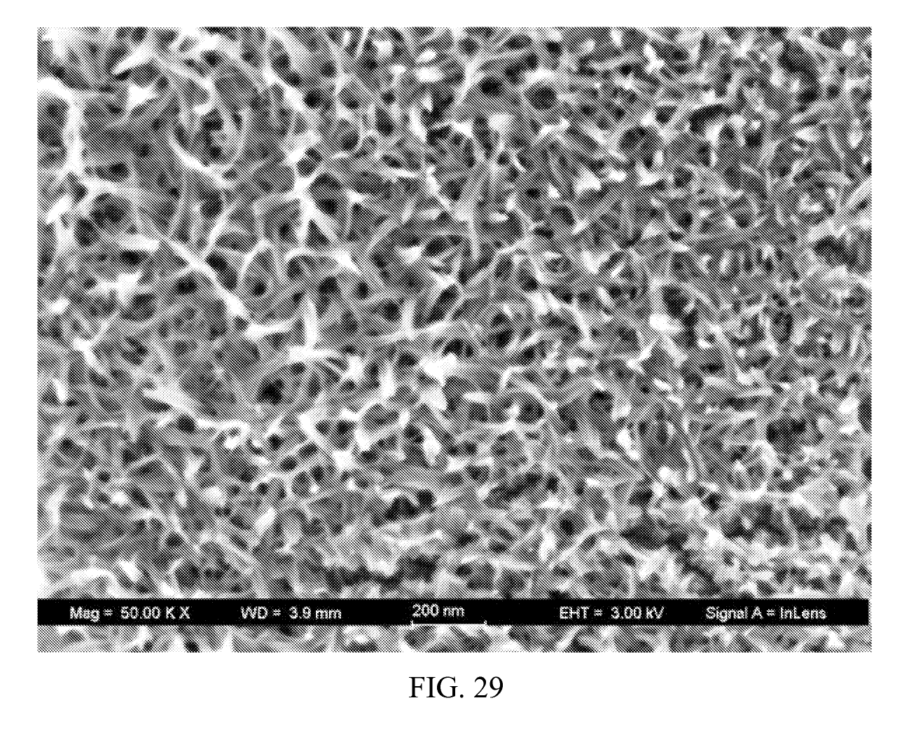

FIG. 29 shows the SEM micrograph of the niobium foil subject to the conditions set forth for sample 3C in Table 3. Strand-like nanostructures of niobium aggregated in a web form with high surface area and uniformity were observed on the surface of the anode. FIG. 29 shows the anode at a magnification of 75,000×. The nanostructures appear well-defined and uniform.

### Sample 3D

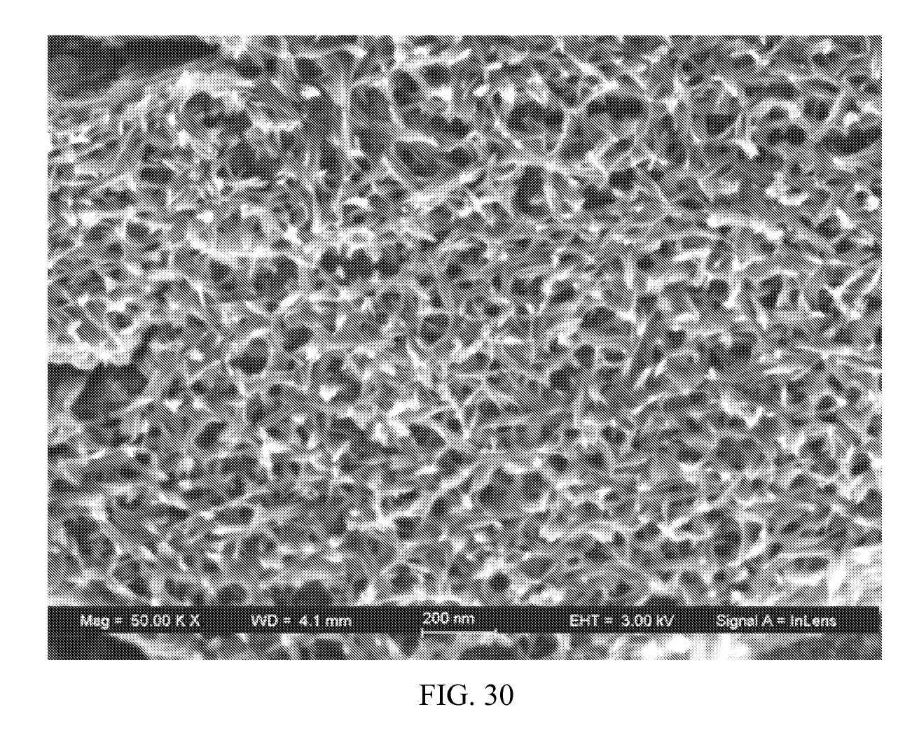

FIG. 30 shows the SEM micrograph of the niobium foil subject to the conditions set forth for sample 3D in Table 3. Strand-like nanostructures of niobium aggregated in a web form with high surface area and uniformity were observed on the surface of the anode. FIG. 30 shows the anode at a magnification of 75,000×. The nanostructures appear well-defined and uniform.

### Sample 3E-3H

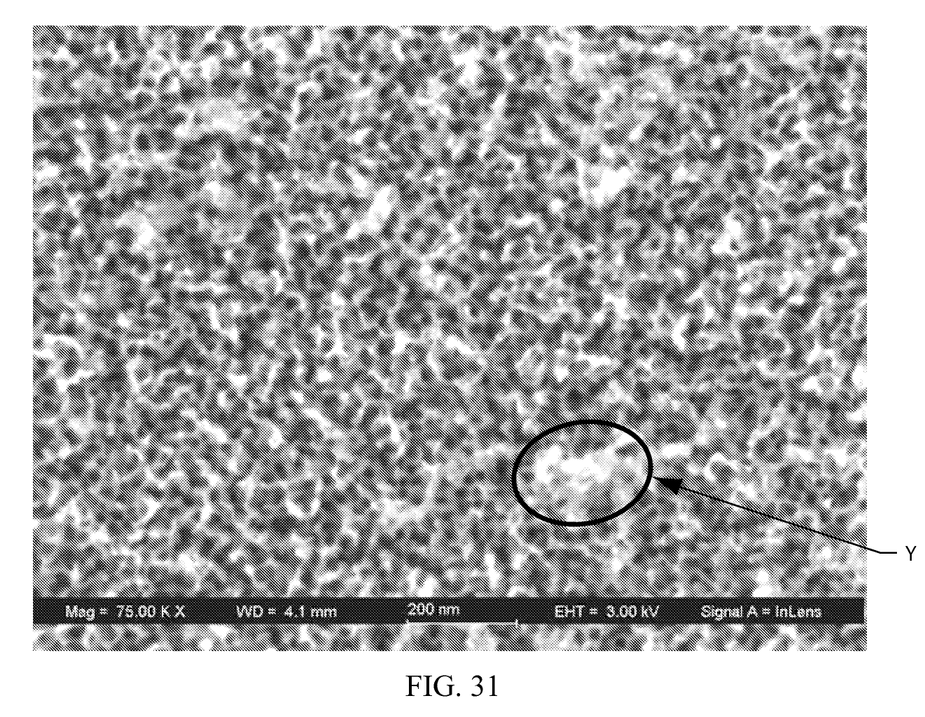

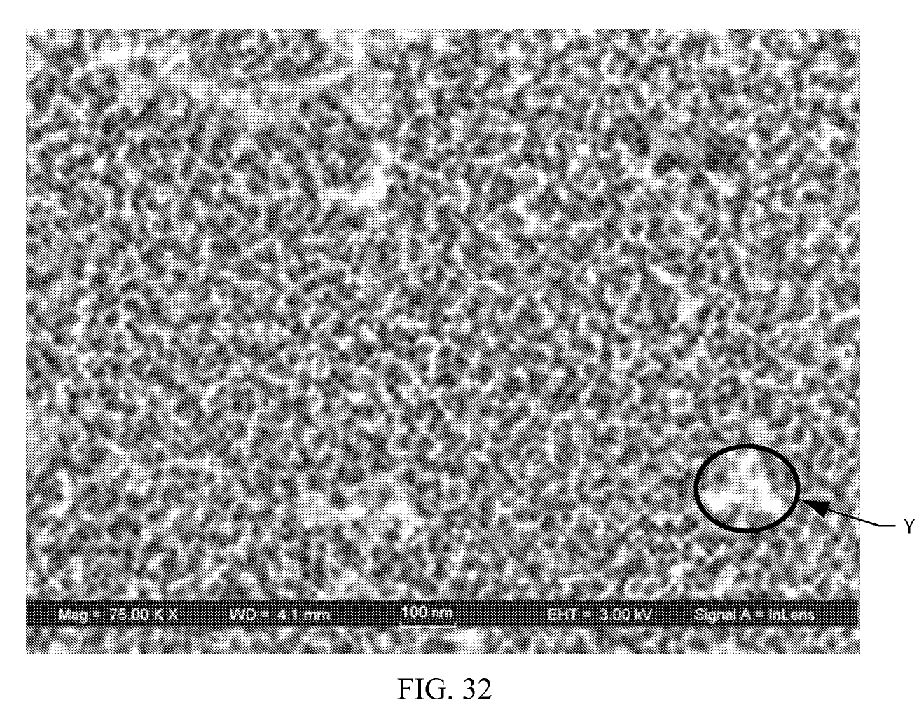

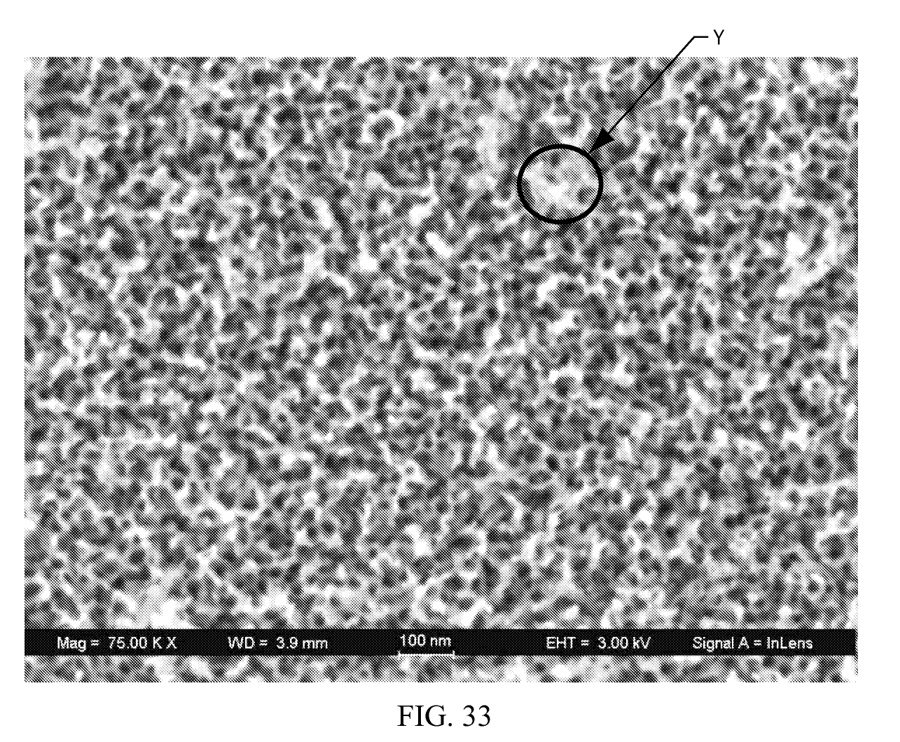

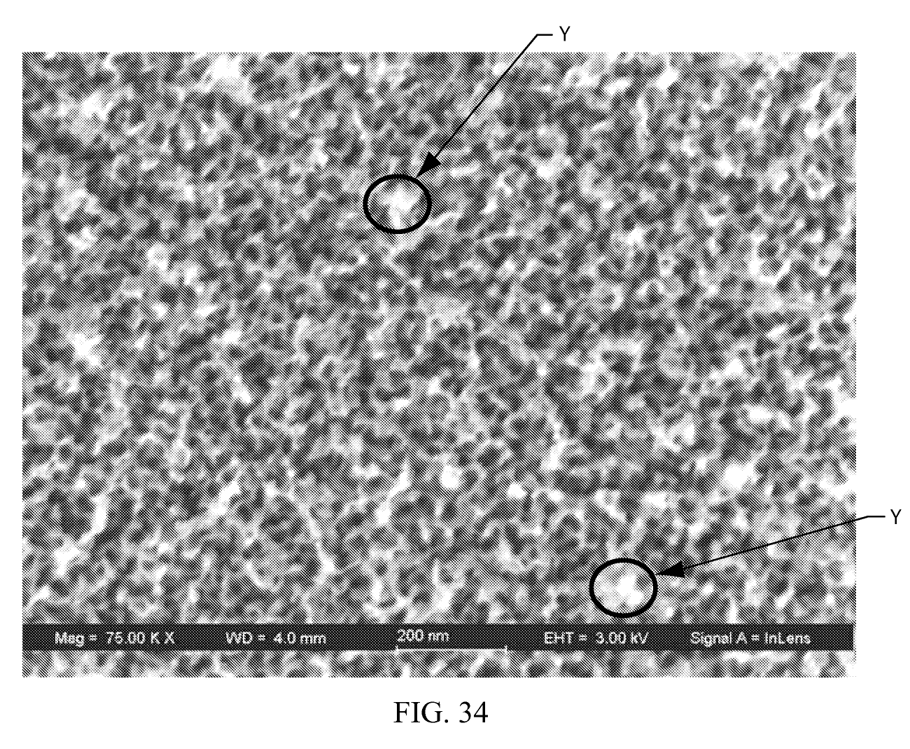

FIGS. 31-34 show the SEM micrograph of the niobium foil subject to the conditions set forth for samples 3E-3H in Table 3, respectively. Porous network-like structures predominately circular pores formed on the anode in each case. FIGS. 31-34 show the anodes at a magnification of 75,000× and show that the nanostructures formed somewhat uniformly. Each of the micrographs shows some irregular portions of the structure where the pores appear closed (Y).

### Example 4

Additional experiments were performed using the same experimental set up as described in the Examples above; however, rather than niobium foils, glass substrates with thin films of niobium were used. The niobium film was prepared by physical vapor deposition.

In this series of experiments, the niobium/glass substrates were subjected to an electrochemical potential of 5V in a 5M electrolyte solution at room temperature. The additional details of the experiments are set forth in Table 4 below.

TABLE 4
Niobium on Glass Samples

| Sample | Substrate Description | Electrolyte | Time (min) |
|---|---|---|---|
| 4A | 200 nm Nb on glass | NaOH | 30 |
| 4B | 200 nm Nb on glass | NaOH | 5 |
| 4C | 100 nm Nb on glass | NaOH | 1 |
| 4D | 100 nm Nb on glass | KOH | 1 |
| 4E | 100 nm Nb on glass | NaOH | 2.5 |
| 4F | 100 nm Nb on glass | KOH | 2.5 |
| 4G | 200 nm Nb on glass | NaOH | 2.5 |
| 4H | 200 nm Nb on glass | KOH | 2.5 |
| 4J | 200 nm Nb + 85 nm ITO on glass | NaOH | 2.5 |
| 4K | 200 nm Nb + 85 nm ITO on glass | KOH | 2.5 |
| 4L | 200 nm Nb + 200 nm Ti on glass | NaOH | 5 |

### Sample 4A

No SEM micrographs or physical data was collected for sample 4A as the niobium film was stripped during the electrochemical experiment.

### Sample 4B

FIG. 14 shows the SEM micrograph of the niobium film subject to the conditions set forth for sample 4B in Table 4. Tentacle-like nanostructures were observed. As shown in FIG. 14, which is the anode at a magnification of 75,000×, some of the structures cross and/or intersect. Additionally, optical images show that the layer of nanostructures is transparent.

### Sample 4C

FIG. 15 shows the SEM micrograph of the niobium film subject to the conditions set forth for sample 4C in Table 4. As with Sample 4B, tentacle-like nanostructures were observed. As shown in FIG. 15, which is the anode at a magnification of 75,000×, some of the structures cross and/or intersect. Additionally, optical images show that the layer of nanostructures is transparent.

### Sample 4D

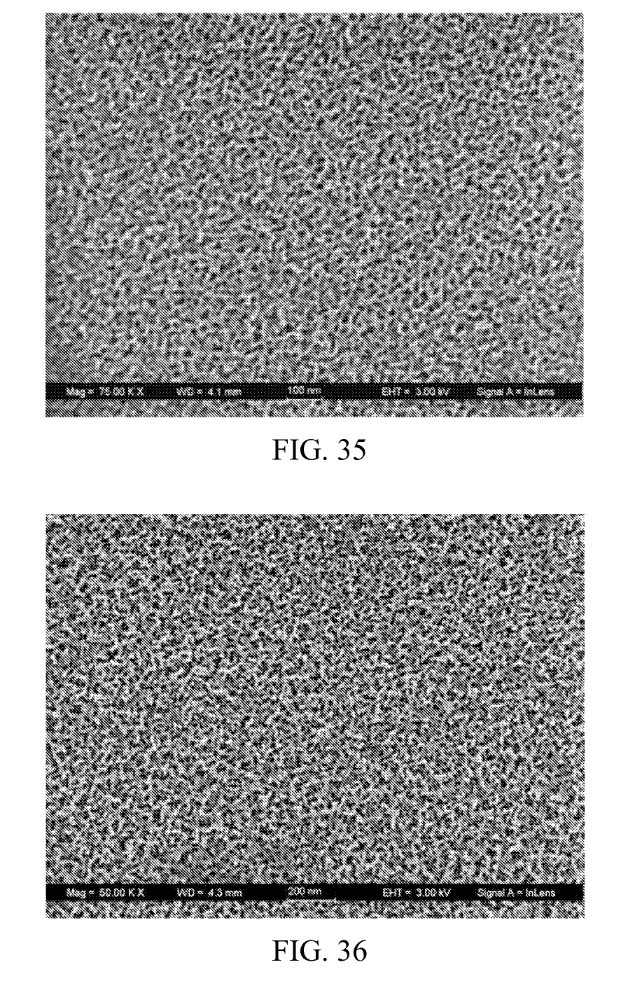

FIG. 35 shows the SEM micrograph of the niobium film subject to the conditions set forth for sample 4D in Table 4. Porous network-like structures with circular pores formed on the anode. FIG. 35 shows the anode at a magnification of 75,000×, and shows that the nanostructures formed somewhat uniformly.

### Sample 4E

FIG. 36 shows the SEM micrograph of the niobium film subject to the conditions set forth for sample 4E in Table 4. Porous network-like structures with circular pores formed on the anode. FIG. 36 shows the anode at a magnification of 75,000×, and shows that the nanostructures formed somewhat uniformly.

### Sample 4F

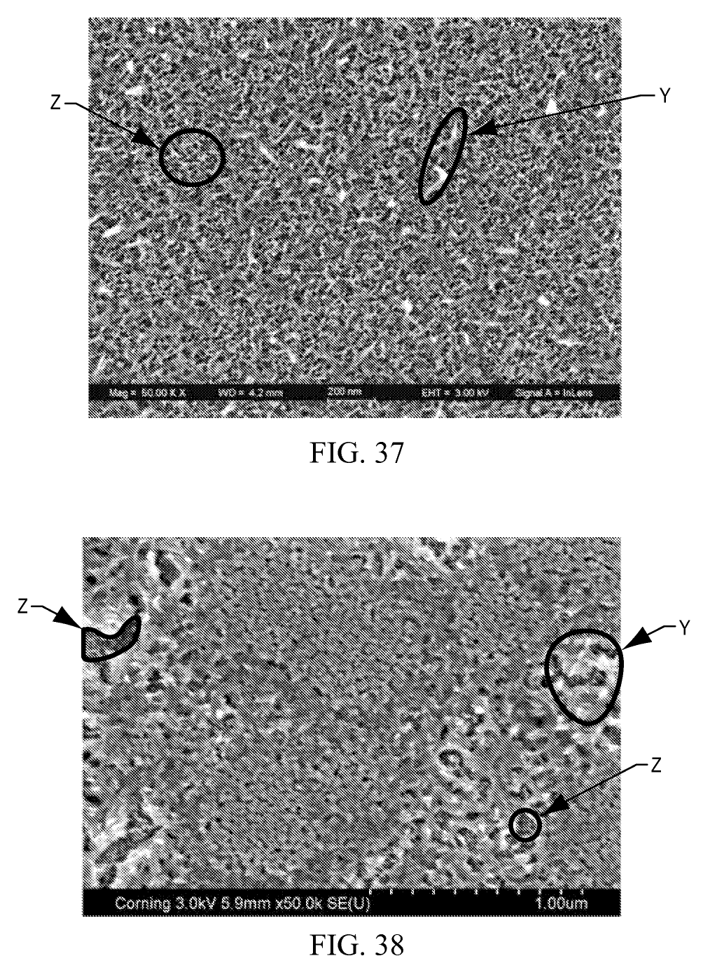

FIG. 37 shows the SEM micrograph of the niobium film subject to the conditions set forth for sample 4F in Table 4. In FIG. 37, the anode is at a magnification of 75,000× and shows some webbed strand-like nanostructures (Y). FIG. 37 also shows porous network-like structures with circular pores (Z).

### Sample 4G

FIG. 38 shows the SEM micrograph of the niobium film subject to the conditions set forth for sample 4G in Table 4. In FIG. 38, the anode is at a magnification of 75,000× and shows webbed strand-like nanostructures (Y) with some porous network-like structures with circular pores (Z).

### Sample 4H

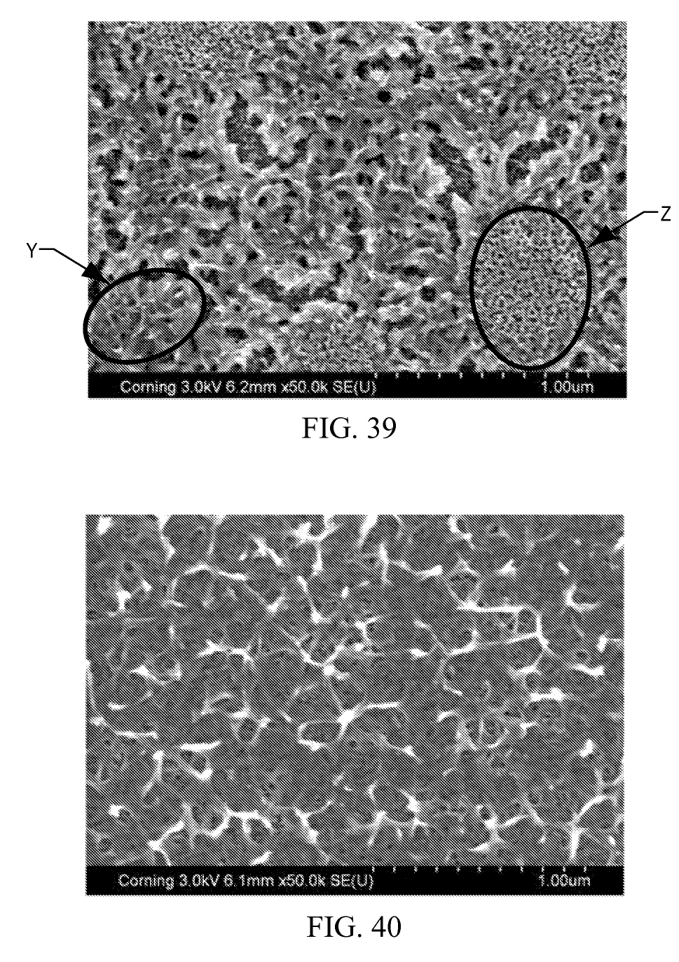

FIG. 39 shows the SEM micrograph of the niobium film subject to the conditions set forth for sample 4H in Table 4. In FIG. 39, the anode is at a magnification of 75,000× and shows webbed strand-like nanostructures (Y) with some porous network-like structures with circular pores (Z). The structures of sample 4H are like those of sample 4G but show more definition.

### Sample 4J

FIG. 40 shows the SEM micrograph of the niobium film with an ITO layer subject to the conditions set forth for sample 4J in Table 4. Strand-like nanostructures of niobium aggregated in a web form with high surface area and uniformity were observed on the surface of the anode. FIG. 40 shows the anode at a magnification of 75,000×.

### Sample 4K

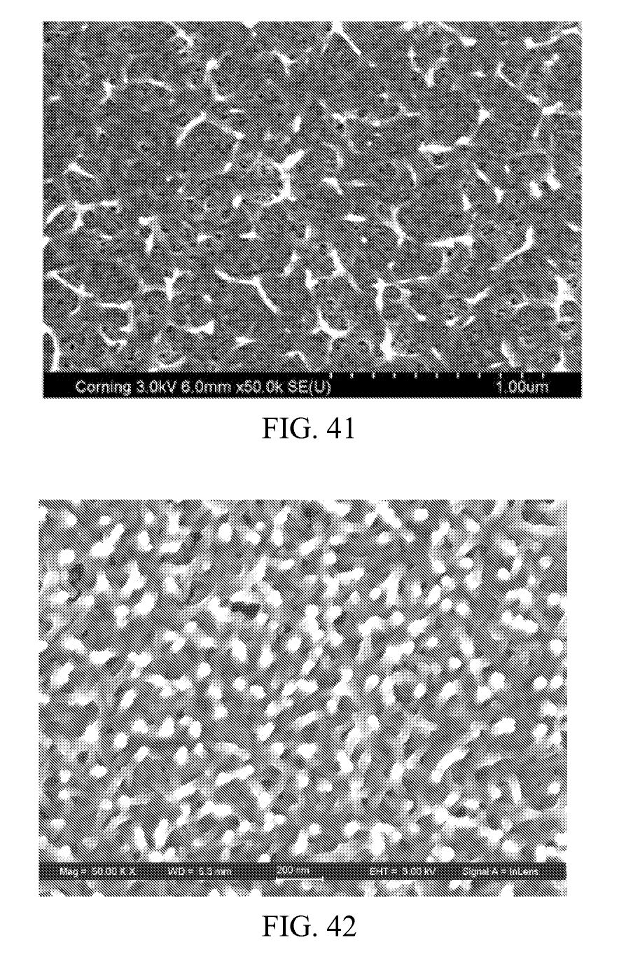

FIG. 41 shows the SEM micrograph of the niobium film with an ITO layer subject to the conditions set forth for sample 4K in Table 4. Strand-like nanostructures of niobium aggregated in a web form with high surface area and uniformity were observed on the surface of the anode. FIG. 41 shows the anode at a magnification of 75,000×.

### Sample 4L

FIG. 42 shows the SEM micrograph of the niobium film with a titanium layer subject to the conditions set forth for sample 4L in Table 4. Tentacle-like nanostructures were observed on the surface of the anode. As shown in FIG. 42, which is the anode at a magnification of 50,000×, some of the structures cross and/or intersect. Additionally, optical images show that the layer of nanostructures is transparent.

What is claimed is:

1. Niobium nanostructures, wherein the nanostructures have strand-like morphology.

2. The niobium nanostructures of claim 1, wherein the strand-like nanostructures have a thickness of 20 nm or less.

3. The niobium nanostructures of claim 1, wherein the strand-like nanostructures are aggregated.

4. The niobium nanostructures of claim 1, wherein the aggregated strand-like nanostructures are webbed.

5. The niobium nanostructures of claim 1, wherein the aggregated strand-like nanostructures are bushes.

6. Niobium nanostructures, wherein the nanostructures have worm-like morphology.

7. The niobium nanostructures of claim 6, wherein the worm-like nanostructures have a diameter of 50 nm or less.

8. Material comprising niobium nanoparticles in porous network-like structures.

9. The material of claim 8, wherein the porous network-like structures comprise pores having a diameter of 100 nm or less.

10. The material of claim 8, wherein the porous network-like structures comprise walls having a thickness of 50 nm or less.

11. Niobium nanostructures, wherein the nanostructures have sphere-like morphology.

12. The niobium nanostructures of claim 11, wherein the sphere-like nanostructures have a diameter of 100 nm or less.

13. The niobium nanostructures of claim 11, wherein the sphere-like nanostructures are aggregated.

14. Niobium nanostructures, wherein the nanostructures have belt-like morphology.

15. The niobium nanostructures of claim 14, wherein the belt-like nanostructures have a thickness of 50 nm or less.

16. The niobium nanostructures of claim 14, wherein the belt-like nanostructures are aggregated.

17. Niobium nanostructures, wherein the nanostructures have tentacle-like morphology.

18. The niobium nanostructures of claim 17, wherein the belt-like nanostructures have a diameter of 100 nm or less.

19. A method for making the niobium nanostructures of claim 1, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanostructures on at least the surface of the anode.

20. A method for making the niobium nanostructures of claim 6, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanostructures on at least the surface of the anode.

21. A method for making the material comprising niobium nanoparticles of claim 8, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanoparticles on at least the surface of the anode.

22. A method for making the niobium nanostructures of claim 11, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanostructures on at least the surface of the anode.

23. A method for making the niobium nanostructures of claim 14, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanostructures on at least the surface of the anode.

24. A method for making the niobium nanostructures of claim 17, comprising:
providing an electrolytic cell, which comprises an anode and a cathode disposed in an electrolyte comprising a hydroxide, wherein the anode is comprised of a niobium surface exposed to the electrolyte; and
applying an electrical potential to the electrolytic cell for a period of time sufficient to obtain niobium nanostructures on at least the surface of the anode.

25. The method of claim 24, wherein the anode further comprises at least one substrate chosen from glass, titanium, and indium-tin oxide coated glass.
